(19) United States
(12) Patent Application Publication
(10) Pub. No.: US 2026/0139337 A1
(43) Pub. Date: May 21, 2026

(54) IRON FEEDSTOCK CONVERSION SYSTEM WITH IMPROVED EFFICIENCY

(71) Applicant: ELECTRASTEEL, INC., Boulder, CO (US)

(72) Inventors: Philip WAGNER, Boulder, CO (US); Harsha VEMPATI, Boulder, CO (US); Colleen WALLACE, Boulder, CO (US); Sandeep NIJHAWAN, Boulder, CO (US); Ai Quoc PHAM, Boulder, CO (US); Adolfredo ALVAREZ, Boulder, CO (US)

(73) Assignee: ELECTRASTEEL, INC., Boulder, CO (US)

(21) Appl. No.: 19/106,083

(22) PCT Filed: Sep. 25, 2023
(86) PCT No.: PCT/US2023/033609

§ 371 Date: Feb. 24, 2025

Related U.S. Application Data
(60) Provisional application No. 63/410,063, filed on Sep. 26, 2022.

(51) Int. Cl. C21B 15/02; C22B 3/08; C25C 7/06; C25D 3/20

(52) U.S. Cl. CPC C21B 15/02; C22B 3/08; C25C 7/06; C25D 3/20

(57) ABSTRACT

Included herein are methods of dissolving and purifying an ore containing hematite and/or magnetite iron oxide, the method comprising: thermally reducing a first portion of the ore at sufficient temperature and for a sufficient time to convert a portion of the iron oxide to magnetite to produce high-magnetite ore; thermally reducing a second portion of the ore at sufficient temperature and for a sufficient time to convert a portion of the iron oxide to metallic iron to produce high-metallic ore; first contacting an acid solution with the high-magnetite ore; and then second contacting

### CROSS-REFERENCE TO RELATED APPLICATIONS

This application claims the benefit of priority to U.S. Provisional Patent Application No. 63/410,063 filed Sep. 26, 2022 which is hereby incorporated by reference in its entirety.

### BACKGROUND OF THE INVENTION

Iron oxide ores may be converted into relatively pure metallic iron by removing oxygen (i.e., reducing the oxides) and recovering metallic iron in a form that can be processed into useful goods in subsequent processes. Iron can then be made into steel by adding a small quantity of carbon and other elements, depending on the type of steel to be made. For thousands of years, both of these tasks (reduction and carbon addition) have been achieved predominantly by heating iron ore to very high temperatures (e.g., about 1,700° C.) in the presence of carbon, typically produced by burning coal (or coke). Carbon monoxide produced by burning the coal or coke combines with oxygen in the iron oxides, thereby reducing the oxides to metallic iron and releasing carbon dioxide. In fact, modern steel production accounts for about 10% of global CO₂ emissions.

### SUMMARY OF THE INVENTION

This application relates generally to the field of metallurgy, and more particularly to systems and methods for electrochemically converting an iron feedstock material into metallic iron.

Aspects disclosed herein include methods of dissolving and purifying an ore containing hematite and/or magnetite iron oxide, the method comprising: thermally reducing a first portion of the ore at sufficient temperature and for a sufficient time to convert a portion of the iron oxide to magnetite to produce high-magnetite ore: thermally reducing a second portion of the ore at sufficient temperature and for a sufficient time to convert a portion of the iron oxide to metallic iron to produce high-metallic ore; first contacting an acid solution with the high-magnetite ore; and then second contacting the acid solution with the high-metallic ore until at least one precipitate is formed.

Aspects disclosed herein include, in an iron conversion system comprising an acid regeneration cell, an impurity removal vessel, and an iron electroplating cell that is separate from the acid regeneration cell, methods comprising: electroplating metallic iron from an electrolyte solution containing ferrous iron ions and less than 0.1 mol/l ferric iron ions and less than 0.01 mol/l aluminum ions; determining that the ferrous iron ion concentration has dropped to a pre-determined low-end ferrous concentration; concentrating the electrolyte by removing water until the ferrous iron ion concentration rises to a pre-determined high-end ferrous concentration; and electroplating metallic iron from the concentrated electrolyte.

Aspects disclosed herein include, in an iron conversion system comprising an acid regeneration cell, an impurity removal vessel, and an iron electroplating cell that is separate from the acid regeneration cell, methods comprising: in a purifying plating cell, first electroplating metallic iron from an electrolyte solution containing ferrous iron ions and more than 0.01 mol/l aluminum ions; to form a purified electrolyte and a lower-purity iron product; collecting a precipitate containing at least one aluminum compound from the purifying plating cell; and after said first electroplating, directing the purified electrolyte into a product plating cell and electroplating a higher-purity iron product.

Aspects disclosed herein include, in an iron conversion system comprising an acid regeneration cell and an iron electroplating cell that is separate from the acid regeneration cell, methods comprising: crystallizing ferrous sulfate from a first electrolyte solution exiting the acid regeneration solution; dissolving the ferrous sulfate crystals in a second electrolyte solution; and electroplating metallic iron from the second electrolyte solution in the electroplating cell.

### BRIEF DESCRIPTION OF THE DRAWINGS

FIG. 1 is a schematic diagram illustrating a decoupled two-step iron conversion system including an acid regeneration subsystem, an iron plating subsystem, and example fluid flows between subsystems.

FIG. 2 is a schematic diagram illustrating an iron feedstock conversion process including cyclically re-concentrating a plating electrolyte solution.

FIG. 3 is a schematic diagram illustrating an iron feedstock conversion process including a purification plating cell for removing some impurities from a plating electrolyte solution.

FIGS. 4A-4E: FIG. 4A is a solubility diagram illustrating solubility of various metal hydroxides at varying solution pH values. FIG. 4B and FIG. 4C are solubility diagrams illustrating solubility of various iron phosphates and iron oxides. FIG. 4D is a solubility diagram illustrating solubility of iron phosphate and ferric iron hydroxide. FIG. 4E is a solubility diagram illustrating solubility of aluminum phosphate and aluminum hydroxide.

FIG. 5 is a process flow diagram showing certain exemplary aspects, including use of H₂ generated during iron electroplating in a process for converting iron oxides such as hematite to magnetite, followed by dissolution of the magnetite coupled with an acid regeneration cell.

FIG. 6 is a schematic system diagram illustrating an example system and process for dissolving variously-treated ores coupled to an acid regeneration system.

FIG. 7 is a diagram of an exemplary iron electroplating flow cell, according to certain aspects.

FIG. 8 is a schematic diagram illustrating a two-step iron conversion system with various sub-systems.

FIG. 9A and FIG. 9B are schematic process flow diagrams illustrating alternative processes for allocating an iron-rich acidic solution from a dissolution subsystem to anolyte and catholyte tanks of a plating subsystem.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of this disclosure.

In various aspects, the present disclosure provides processes, systems, and methods for enabling efficient, low-temperature aqueous hydrometallurgical processes for producing pure iron from various iron source materials including relatively low-purity iron feedstock materials. In broad terms, an iron feedstock material is dissolved in an acidic aqueous solution, and metallic iron is electrolytically plated and removed as a solid. In various aspects, iron feedstock materials or aqueous iron may be converted from one form to another during one or more process steps.

As used herein, the terms “pure iron” and “high purity iron” are used in a relative sense to refer to a metallic iron material that is more pure than an iron source material, and contains an acceptably low quantity of one or more impurities.

As used herein, the terms “iron source material” and “iron feedstock” are used synonymously to refer to iron-containing materials that may be used as inputs into the various systems and methods described herein. “Iron source materials” and “iron feedstocks” may include iron in any form, such as iron oxides, hydroxides, oxyhydroxides, carbonates, or other iron-containing compounds, ores, rocks or minerals, including any mixtures thereof, in naturally-occurring states or beneficiated, purified, and/or at least partially chemically reduced states. The term “iron-containing ore” or simply “iron ore” may include materials recognized, known, or referred to in the art as iron ore(s), rock(s), natural rock(s), sediment(s), natural sediment(s), mineral, and/or natural mineral(s), whether in naturally-occurring states or in beneficiated or otherwise purified or modified states. Some aspects of processes and systems described herein may be particularly useful for iron ores including hematite, goethite, magnetite, taconite limonite, siderite, ankerite, turgite, bauxite, or any combination thereof.

Optionally, an iron source material or iron feedstock may comprise an iron metal material, such as, but not limited to, iron dust (e.g., fine particulate produced as a byproduct of ironmaking or steelmaking processes in blast furnaces, oxygen furnaces, electric arc furnaces, etc.), iron powder, scrap steel, and/or scrap cast iron. “Iron source materials” and “iron feedstocks” may also contain various other non-iron materials, generally referred to as “impurities.”

As used herein, the term “impurity” refers to an element, aqueous ion, or compound other than a desired final product material (e.g., iron). In various aspects, depending on the intended end-use of a product material, a given element or compound may or may not be considered an “impurity.” In some cases, one or more elements or compounds that may be impurities to one process or sub-process may be isolated or purified, collected, and sold as a secondary product material.

As used herein the term “deleterious impurity,” or variations of the phrase, refer to elements, aqueous ions, or compounds that negatively impact the quality of an electroplated iron product, either by being incorporated into the product or by interfering with formation of the electroplated product. Deleterious impurities include but are not limited to aqueous ions or compounds of aluminum, phosphorus, silicon, titanium, or combinations of these or others. For clarity, the terms “impurity” and “deleterious impurity” are neither mutually exclusive nor mutually inclusive, and both terms may or may not refer to the same elements, ions, or compounds.

In various aspects herein, various compositions, compounds, or solutions may be substantially “isolated” or “purified” to a degree sufficient for the purposes described herein. In various aspects, a substantially purified composition, compound or formulation (e.g., ferrous iron solutions, ferric iron solutions, or plated metallic iron) may have a chemical purity of 90% (e.g., by molarity of ionic concentrations or by weight), optionally for some applications 95%, optionally for some applications 99%, optionally for some applications 99.9%, optionally for some applications 99.99%, and optionally for some applications 99.999% pure.

Reference made herein to a “tank” is intended to include any vessel suitable for containing liquids, including highly acidic or caustic aqueous solutions if needed. In some aspects, such a vessel may include additional features or components to assist or improve mixing of solid and/or liquid contents of the vessel. For example, a dissolution tank may include passive or actively operated structures or features for agitating a solution or solid/liquid mixture. A dissolution tank or other tank useful in the systems and methods herein may also include features to allow for sparging a gas into or through solid and/or liquid contents of the tank to increase gas contact with solid and/or liquid materials within the tank. Various tanks may also include baskets, sieves, pans, filters, or other structures to collect and separate solids from liquids. In some aspects, a tank may be configured to direct liquid or gas flow through the tank in such a way as to agitate the mixture therein (e.g., flow-directing structures, pumps, impellers, baffles, impellers, stir-bars, stir blades, vibrators, cyclonic flow channels, etc.). Tanks may also be configured for adding fluids and/or solids to and/or removing fluids and/or solids from the tank for any purpose, including those described in various embodiments and aspects herein.

In some aspects described herein, a system for converting iron ore into iron metal (i.e., an “iron conversion system”) may comprise two or more subsystems. Some aspects include a feedstock pretreatment subsystem in which an iron-containing feedstock may be physically and/or chemically modified prior to introduction to subsequent subsystems. Some aspects include a “dissolution subsystem” in which components of an iron-containing feedstock are dissolved into an aqueous solution. Some aspects further include an “iron plating subsystem” in which dissolved iron is electrochemically reduced to iron metal in an “electroplating” (or simply “plating”) process. The iron metal may subsequently be removed from the iron plating subsystem.

In some aspects, an aqueous iron-containing solution may be transferred to and treated in a “transition subsystem” after leaving the dissolution subsystem and before being delivered to the plating subsystem. Treatments within the transition subsystem may include pH adjustment, impurity removal, filtration, or other processes. In some aspects, any of the above sub-systems may be fluidically coupled to one another by an “inter-subsystem fluidic connection” which may comprise any combination of fluid-carrying conduits (pipes, channels, troughs, etc.) and any number of flow control devices, including valves, pumps, expansion chambers, gas-liquid separators, solid-liquid separators, filters, or other similar devices.

The term “iron electroplating” (or “iron plating” as used synonymously herein) refers to a process by which dissolved iron is electrochemically reduced to metallic iron on a cathodic surface. Equivalent terms “electrodeposition,” “electroforming,” and “electrowinning” are also used herein synonymously with “iron electroplating.” The shape or form-factor of the electroplated iron need not be a “plate” by any definition of that term. For example, electroplated iron may take any shape or form and may be deposited on any suitable cathodic surface as described in various aspects herein.

The term “dissolution step” includes processes occurring in the dissolution subsystem, including but not limited to dissolution of iron oxide materials and electrochemical process(es) occurring in or via an “acid regeneration cell,” including but not limited to the claimed step of electrochemically reducing Fe³⁺ ions to Fe²⁺ ions in the acid regeneration cell. Dissolution step processes may also include oxidizing water or hydrogen gas in the first electrochemical cell, for example, to generate protons, which may allow for regeneration of the acid (in the form of protons) that is used to facilitate dissolution of an iron-containing feedstock.

The term “iron plating step” includes process(es) occurring in the iron plating subsystem, including but not limited to the electrochemical process(es) occurring in or via the claimed “plating cell,” including but not limited to the step of “electrochemically reducing” Fe²⁺ ions to Fe metal in the “plating cell” also referred to herein as the “plating cell.” The iron plating process may also include oxidizing a second portion of Fe²⁺ ions to form Fe³⁺ ions. In some aspects, such Fe²⁺ ions may be provided from the first electrochemical cell or from another part of the system.

As used herein, unless otherwise specified, the terms “ferrous iron solution” or “ferrous solution” may refer to an aqueous solution that contains dissolved iron that is at least predominantly (i.e., between 50% and 100%) in the Fe²⁺ (i.e., “ferrous”) ionic state with the balance of dissolved iron being in the “ferric” Fe³⁺ state. Similarly the term “ferrous ion” refers to one or more aqueous ions in the ferrous (Fe²⁺) state.

As used herein, unless otherwise specified, the terms “ferric iron solution” or “ferric solution” may refer to an aqueous solution that contains dissolved iron that is at least predominantly (i.e., between 50% and 100%) in the Fe³⁺ (i.e., “ferric”) ionic state with the balance of dissolved iron being in the “ferrous” Fe²⁺ state. Similarly the term “ferric ion” refers to one or more aqueous ions in the ferric (Fe³⁺) state. Either “ferric solutions” or “ferrous solutions” may also contain other dissolved ions or colloidal or particulate materials, including impurities.

As used herein, any reference to a “PEM” or “proton exchange membrane” may be interpreted as also including a “CEM” or “cation exchange membrane”, both terms may include any available membrane material that selectively allows passing positively charged cations and/or protons. The abbreviation “AEM” is used to refer to anion exchange membranes selective to negatively-charged aqueous ions and includes any available anion-selective membrane.

As used herein, aqueous protons and electrochemically generated protons are intended to be inclusive of aqueous protons and aqueous hydronium ions.

As used herein, the term “unprocessed ore” refers to an iron-containing ore that has been neither thermally reduced nor air roasted according to aspects disclosed herein. Unprocessed ore is optionally a raw iron-containing ore.

As used herein, electrochemically generated ions, such as electrochemically generated protons and electrochemically generated iron ions (e.g., Fe²⁺, Fe³⁺), refer to ions that are generated or produced in an electrochemical reaction. For example, electrochemical oxidation of water at an anode may electrochemically generated protons and electrochemically generated oxygen.

As used herein, the term “thermally reducing” refers to a thermal treatment at an elevated temperature in the presence of a reductant. Thermal reduction is also referred to in the art as reduction roasting. Optionally, thermal reduction is performed at a temperature selected from the range of 200° C. and 600° C. Optionally, the reductant is a gas comprising hydrogen (H₂) gas, carbon monoxide, or other reducing gas or combinations of gases. Additional description and potentially useful aspects of thermal reduction may be found in the following reference, which is incorporated herein in its entirety: “Hydrogen reduction of hematite ore fines to magnetite ore fines at low temperatures”, Hindawi, Journal of Chemistry, Volume 2017, Article ID 1919720.

As used herein, the term “parasitic hydrogen” or hydrogen (H₂) from a “parasitic hydrogen evolution reaction of an iron electroplating process” refers to hydrogen (H₂) gas electrochemically generated by a side reaction concurrently with an iron electroplating reaction (e.g., Fe²⁺ to Fe or Fe³⁺ to Fe²⁺ to Fe) in the same electrochemical cell. Additional description and potentially useful aspects of pertaining to parasitic hydrogen evolution may be found in the following reference, which is incorporated herein in its entirety: “An investigation into factors affecting the iron plating reaction for an all-iron flow battery”, Journal of the Electrochemical Society 162 (2015) A108.

As used herein, the term “air roasting” refers to a thermal treatment performed at an elevated temperature in the presence of air or other oxygen-containing gas. Air roasting of ore, such as iron-containing ore, can break down or decrease average particle size of an ore. Optionally, air roasting is performed at temperature selected from the range 300° C. and 500° C. Additional description and potentially useful aspects of air roasting may be found in the following reference, which is incorporated herein in its entirety: “Study of the calcination process of two limonitic iron ores between 250° C. and 950° C.”, Revista de la Facultad de Ingeneria, p. 33 (2017).

As used herein, the term “redox couple” refers to two chemical species, such as ions and/or molecules, that correspond to a reduced species and an oxidized species of an electrochemical reaction or a half-cell reaction. For example, in the electrochemical reduction of Fe³⁺ ions to Fe²⁺ ions, the corresponding redox couple is Fe³⁺/Fe²⁺, where Fe³⁺ is the oxidized species and Fe²⁺ is the reduced species. As used herein, the order in which a redox couple is described (e.g., Fe³⁺/Fe²⁺ vs. Fe²⁺/Fe³⁺) is not intended to denote which species is the reduced species and which is the oxidized species. Additional description and potentially useful aspects of redox couples may be found in the following reference, which is incorporated herein in its entirety: “Redox-Principles and Advanced Applications”: Book by Mohammed Khalid, Chapter 5: Redox Flow Battery Fundamental and Applications.

As used herein, the terms “steady state” and “steady-state” generally refer to a condition or a set of conditions characterizing a process, a method step, a reaction or reactions, a solution, a (sub) system, etc., that are true longer than they are not true during operation or performance of the process, method step, reaction or reactions, solution, (sub) system, etc. For example, dissolution of an ore or feedstock may be characterized by a steady state condition, wherein the steady state condition is true during at least 50%, optionally at least 60%, optionally at least 70%, optionally at least 80%, optionally at least 90%, optionally at least 95% of a time during which the dissolution is occurring. For example, a steady state condition may be exclusive of conditions characterizing the transient start-up and shut-down phases of a process such as dissolution of a feedstock.

The term “cathodic chamber” refers to a region, compartment, vessel, etc. comprising a cathode, or at least a portion or surface thereof, and a catholyte. The term “anodic chamber” refers to a region, compartment, vessel, etc. comprising an anode, or at least a portion or surface thereof, and an anolyte.

As used herein, the term “iron-rich solution” may be also referred to as an “iron iron-rich solution” or a “ferrous product solution”, corresponding to the iron ion-rich solution formed in the ore dissolution subsystem or in any other system.

As used herein, the term “ore dissolution subsystem” may also be referred to as the “dissolution subsystem”. “first subsystem”, and “STEP 1.” The “dissolution subsystem” comprises the “acid regenerator” described herein.

As used herein, the term “iron-plating subsystem” may also be referred to as the “second subsystem” and “STEP 2.”

As used herein, the term “precipitation pH” refers to a pH at which the referenced one or more ions or salts are thermodynamically favored or expected to precipitate out of the host aqueous solution at a particular temperature. Generally, the solubility of ions and salts dissolved in an aqueous solution may depend on the pH of the aqueous solution and temperature of the solution. As PH increases in the acidic region (at a given temperature), many metallic ions form metal hydroxides which tend to precipitate out of the host solution due to decreasing solubility. The precipitation pH is defined herein as the pH corresponding to a point where solubility of a given ion or salt is below a concentration threshold. The precipitation pH may be an upper boundary beyond which the solubility of a given ion or salt is less than 1 mM, optionally less than 0.1 mM.

Unless specified otherwise, aqueous operations and processes may generally be performed at a temperature of between about 50° C. and about 90° C. In some more particular aspects, aqueous operations and processes may be performed at about 50° C.+/−5° C., 60° C.+/−5° C., 70° C.+/−5° C., 80° C.+/−5° C., or 90° C.+/−5° C.

As used herein, the term “metallic iron” refers to a material comprising metallic iron, such as but not limited to scrap iron, electroplated iron, iron powder, etc.

As used herein, the term “supporting salt” and “supporting ion” refers to a salt and ion, respectively, corresponding to or serving as a supporting electrolyte or which form, at least partially, a supporting electrolyte when dissolved in order to increase a conductivity of a host solution. In some aspects, for example, the electrolytes and solutions in either the dissolution subsystem and the plating subsystem may contain dissolved iron species, acid, and additionally inert salts serving as supporting electrolyte to enhance the electrolyte conductivity, which may be particularly beneficial at low ferrous concentrations, wherein the inert salts serving as supporting electrolyte to enhance conductivity may be referred to as supporting salts. Supporting salts may include any electrochemically inert salt such as sodium chloride, potassium chloride, ammonium chloride, sodium sulfate, potassium sulfate, ammonium sulfate, or others, or combinations of salts. The concentration of the supporting salts in the solution, if used, may range from about 0.1 to about 1 M, for example.

As used herein, the term “wt. %” or “wt %” refers to a weight percent, or a mass fraction represented as a percentage by mass. The term “at. %” or “at %” refers to an atomic percent, or an atomic ratio represented as a percentage of a type of atom with respect to total atoms in a given matter, such as a molecule, compound, material, nanoparticle, polymer, dispersion, etc. The term “mol. %” refers to molar percent or percent by moles. The term “vol. %” refers to volume percent.

The terms “substantially” and “approximately” are used interchangeably and refer to a property, condition, or value that is within 20%, 10%, within 5%, within 1%, optionally within 0.1%, or is equivalent to a reference property, condition, or value. In aspects, the terms “substantially” and “approximately” are used interchangeably and refer to a property, condition, or value that is within 20% of a reference property, condition, or value. The term “substantially equal”, “substantially equivalent”, “substantially unchanged”, “approximately”, and “approximately equal to” when used in conjunction with a reference value describing a property or condition, refers to a value that is within 20%, within 10%, optionally within 5%, optionally within 1%, optionally within 0.1%, or optionally is equivalent to the provided reference value. For example, a diameter is approximately equal to 100 nm (or, “is approximately 100 nm”) if the value of the diameter is within 20%, optionally within 10%, optionally within 5%, optionally within 1%, within 0.1%, or optionally equal to 100 nm. The term “substantially greater”, when used in conjunction with a reference value describing a property or condition, refers to a value that is at least 1%, optionally at least 5%, optionally at least 10%, or optionally at least 20% greater than the provided reference value. The term “substantially less”, when used in conjunction with a reference value describing a property or condition, refers to a value that is at least 1%, optionally at least 5%, optionally at least 10%, or optionally at least 20% less than the provided reference value. As used herein, the term “about” means a range of values including the specified value, which a person of ordinary skill in the art would consider reasonably similar to the specified value. In aspects, about and approximately mean within a standard deviation using measurements generally acceptable in the art. In some aspects, about means a range extending to +/−10% of the specified value. In aspects, about means the specified value. In aspects, the terms “about”, “approximately”, and “substantially” are interchangeable and have identical means. For example, a particle having a size of about 1 μm may have a size is within 20%, optionally within 10%, optionally within 5%, optionally within 1%, optionally within 0.1%, or optionally equal to 1 μm.

As used herein, the term “and/or” is used herein, in the description and in the claims, to refer to a single element alone or any combination of elements from the list in which the term and/or appears. For example, a listing of two or more elements having the term “and/or” is intended to cover aspects having any of the individual elements alone or having any combination of the listed elements. For example, the phrase “element A and/or element B” is intended to cover aspects having element A alone, having element B alone, or having both elements A and B taken together. For example, the phrase “element A, element B, and/or element C” is intended to cover aspects having element A alone, having element B alone, having element C alone, having elements A and B taken together, having elements A and C taken together, having elements B and C taken together, or having elements A, B, and C taken together.

As used herein, the term “+” refers to an inclusive range of values, such that “X±Y,” wherein each of X and Y is independently a number, refers to an inclusive range of values selected from the range of X−Y to X±Y. In the cases of “X±Y” wherein Y is a percentage (e.g., 1.0±20%), the inclusive range of values is selected from the range of X−Z to X+Z, wherein Z is equal to X·(Y/100). For example, 1.0±20% refers to the inclusive range of values selected from the range of 0.8 to 1.2.

### DETAILED DESCRIPTION OF THE INVENTION

In the following description, numerous specific details of devices, device components and methods are set forth to provide a thorough explanation of the precise nature of the various inventions described herein. It will be apparent, however, to those of skill in the art that the various inventions can be practiced without these specific details. Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an aspect of devices and methods may nonetheless be operative and useful.

Described herein are various improvements and alternatives to systems and methods relating to a decoupled “two-step” electrochemical iron ore refinement system, including improvements to systems and methods for adjusting the contents or composition of aqueous electrolytes. Aspects herein provide improvements to systems and methods for removing impurities and water from electrolytes.

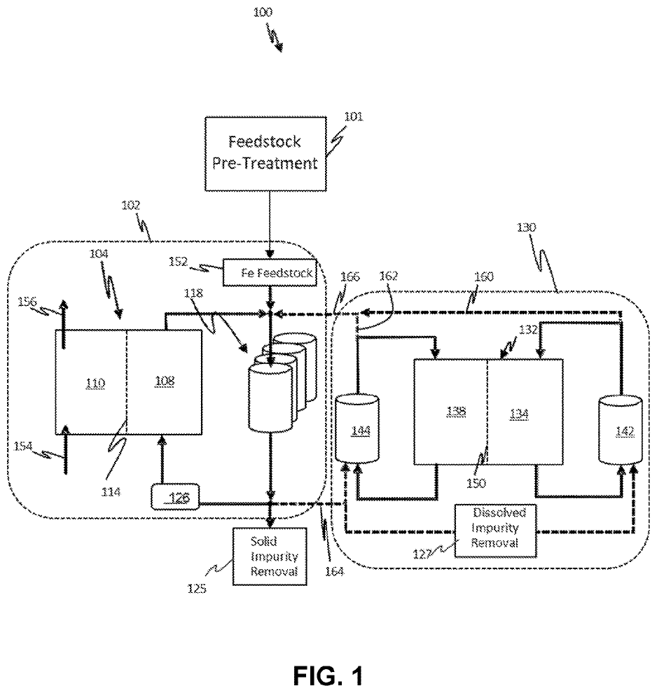

Various aspects of systems and methods for removing various impurities while extracting metallic iron from iron feedstock materials are described in Applicant's International Patent App. No. PCT/US2022/021712, titled “Impurity Removal in an Iron Conversion System” (published as International Patent Pub. No. WO2022204379A1), hereafter the “PCT'712,” and in U.S. Provisional Patent Application No. 63/410,063 filed Sep. 26, 2023 (hereafter, Provis'063), each of which is incorporated herein by reference in its entirety. The system illustrated in FIG. 1 of the present application comprises features illustrated in PCT'712 and Provis'063.

Specifically, FIG. 1 schematically illustrates a system 100 for converting an iron-containing feedstock, such as iron ore, into higher purity metallic iron. The illustrated system 100 broadly includes a feedstock pretreatment subsystem 101, a dissolution/acid regeneration subsystem 102, and an iron plating/removal subsystem 130. As described in PCT'712 and Provis'063, and below herein, some iron feedstock materials may be pre-treated to convert materials into a more easily-dissolvable state. For example, in some aspects, the iron feedstock may be milled or ground to form particles within a desired range prior to introduction into the dissolution tank. In other aspects, the feedstock may be pre-treated by air roasting and/or by thermal reduction prior to introduction to the dissolution tank.

As also described in PCT'712 and Provis'063, the dissolution/acid regeneration subsystem 102 may be configured to dissolve an iron-feedstock material into an acidic electrolyte solution and to reduce a portion of ferric iron (Fe³⁺) into ferrous iron (Fe²⁺) both in order to facilitate faster dissolution and to improve removal of dissolved impurities at block 127 while minimizing loss of iron from the solution. As further described in PCT'712 and Provis'063, and below herein, one method of removing dissolved impurities is to raise the pH of the electrolyte by contacting the electrolyte with metallic iron, causing precipitation of impurities while also consuming excess free protons (H⁺) and converting remaining Fe³⁺ into Fe²⁺.

As described, one source of such metallic iron may be recycling iron produced in the iron plating/removal subsystem. However, while recycling metallic iron from the system 100 provides many benefits (e.g., it may be a higher purity product than other available sources, it is readily available at the facility, etc.), it also incurs costs associated with the input feedstock material and the energy consumed with electroplating and other processing. Therefore, it is desirable to minimize the need for recycling plated iron made by the system 100 back into the same system for removing impurities.

Various systems and methods described below provide the benefit (among other benefits) of decreasing, minimizing, or eliminating the need to recycle plated iron for the purpose of shifting electrolyte pH, consuming acid, consuming ferric ions, and precipitating impurities.

### Creating Metallic Iron by Thermal Reduction

Some examples of feedstock pre-treatment 101 described in PCT'712 and Provis'063, and below herein, include processes for thermally reducing a feedstock material in a hydrogen-containing atmosphere to convert material from a less-dissolvable crystal phase (e.g., hematite (Fe₂O₃) or goethite (FeO(OH))) to a more-dissolvable crystal phase (e.g, magnetite or Fe₃O₄).

As also described in PCT'712 and Provis'063, and below herein, with reference to FIG. 10 of PCT'712, a dissolution system may be configured to sequentially dissolve differently treated ores (e.g., some “raw ore.” some air-roasted ore, and/or some “reduced” ore) so as to optimize usage of acid, with a goal of reaching a minimum excess acid concentration by the time the electrolyte solution exits a dissolution subsystem.

In some aspects of inventions provided herein, two other categories of material may be added to the process of sequential dissolution. In some aspects, a process of thermally-reducing oxidized iron ore (i.e., ores containing substantial quantities of iron in a trivalent form such as goethite, limonite, hematite, etc.) may comprise intentionally reducing a portion of the ore to metallic iron or to partially reduced ore containing metallic iron (referred to herein as “high-metallic” feedstock or ore), and using such high-metallic ore in place of recycling plated iron as described in PCT'172.

In various aspects, a process of thermal reduction to convert a portion of iron oxides in an oxidized ore or other feedstock to metallic iron may be substantially similar to the thermal reduction processes described in PCT'712 and Provis'063 and/or below herein.

In various aspects, “thermal reduction” to produce a product rich in magnetite (Fe₃O₄), also referred to herein as producing a “high-magnetite ore,” may be performed by heating an oxidized ore (or other iron feedstock containing iron oxides, including hematite and/or goethite) in a reducing atmosphere (also referred to herein as a reducing gas) to a temperature of between about 300° C. and 600° C. for a duration of about 1 minute up to about 5 hours, depending on the extent of reduction required and morphology of materials to be reduced. In some aspects, the reducing atmosphere may comprise a gas mixture of about 1% to about 10% hydrogen gas (or other reducing gas) with a balance of an inert gas such as nitrogen, argon or other gas. In some aspects, much higher hydrogen content gas mixes, even up to about 100% H₂, may be used. In some aspects, a reducing gas may also or alternatively comprise other reducing gases such as carbon monoxide, hydrogen sulfide, sulfur dioxide, methane, natural gas, forming gas, or others. In some aspects, a thermal reduction atmosphere may also contain about 5% to about 10% water vapor. In some aspects, the reducing gas atmosphere may comprise syngas, defined as a mixture containing hydrogen and carbon monoxide in various ratios. In various aspects, at least a portion of hydrogen used in a reducing gas may be obtained from other process steps as described herein, such as by the reaction of an acid and metallic iron or as a parasitic side-reaction during electroplating of iron.

In some particular aspects thermal reduction of ore to produce magnetite may comprise holding ore at a temperature of about 300° C. to about 500° C., in some specific aspects to a temperature of about 375° C. 400° C. 425° C., 450° C., 500° C., 525° C., 550° C., or more. In various aspects, when thermally reducing ore, the ore may be exposed to an air (or other non-reducing) atmosphere during a ramp-up time until a target temperature is reached, so as to conserve reducing gas that may be ineffective before reaching the target temperature. In some aspects, a time duration of thermal reduction may begin when the ore material reaches a first target temperature.

In some aspects, it may be desirable to stop thermal reduction of iron ore before complete reduction to iron metal, such as by removing the ore, decreasing the temperature, or maintaining a sufficient humidity level to prevent reduction to iron metal. In other aspects, a portion of the ore may be allowed to reduce to iron metal before proceeding to a dissolution step.

In some aspects, a portion of the feedstock material (e.g., up to about 50% or more) may be intentionally reduced to iron metal by holding temperature for a sufficient time and/or at a low enough humidity that iron metal is formed and/or by increasing the process temperature to a range of about 800° C. to about 1,200° C. for a sufficient time that iron metal is formed (e.g., by transferring material to a second furnace or a region of a first furnace operating at a higher temperature). In some aspects, a separate batch of ore may be reduced to iron metal compared to the portion reduced to magnetite. In other aspects, a first portion of a single batch may be reduced to magnetite while a second portion of the same batch is reduced to iron metal.

In some aspects, both magnetite and metallic iron may be produced in the same furnace. For example, in some aspects, a thermal reduction furnace may be configured such that ore located closest to a reducing gas inlet may be reduced to metallic iron at a faster rate and/or to a greater extent than ore located further away from the reducing gas inlet. In such aspects, the ore closest to the reducing gas inlet may be collected separately from the ore further from the gas inlet (i.e., having a lower percent of metallic iron, such as from about 0% to ˜1% Fe).

In some aspects, a proportion of feedstock thermally reduced to metallic iron in a batch or in a continuous process may be between about 1% and about 50% of the batch or daily quantity of processed feedstock.

Processed feedstock containing a greater proportion of metallic iron than other feedstock material will be referred to herein as “high metallic feedstock.” In particular aspects, about 1%, 2%, 3%, 4%, 5%, 6%, 7%, 8%, 9%, or about 10% of the batch or daily quantity of processed feedstock may be thermally reduced to metallic iron. Such “high metallic feedstock” may be separated from feedstock containing a smaller proportion of metallic iron.

In other aspects, high-magnetite and high-metallic iron products may be produced in a percent magnetite to percent iron ratio of 50%/50%, 55%/45%, 60%/4%, 65%/35%, 70%/30%, 75%/25%, 80%/20%, 85%/15%, 90%/10%, 95%/5%, or 99%/1%.

In various aspects, thermal reduction may be performed in any suitable furnace, reactor, or processing equipment such as rotary kilns, rotating cylindrical furnaces, fluidized bed reactors, rotating-bed furnaces, shaft furnaces, or others. In some aspects, performing thermal reduction of non-magnetic oxidized ores to magnetic magnetite and/or metallic iron may be advantageously performed in a magnetizing roasting process in which the reduced magnetic materials are magnetically separated from non-magnetic materials during or immediately following the roasting/thermal reduction. Examples of magnetizing roasting processes are described for example in U.S. Pat. No. 10,543,491 to Han et. al., U.S. Pat. No. 3,305,345 to Rausch et. al., U.S. Pat. No. 3,189,437 to Boucraut, among others.

In various aspects, electrolyte exiting the dissolution subsystem may be contacted with the high metallic feedstock in a suitable reactor in order to raise pH of the electrolyte, consume all or essentially all remaining ferric (Fe³⁺) ions, and to cause precipitation of materials such as aluminum hydroxide, aluminum phosphate, ferric phosphate, titanium hydroxide, or others. Such contacting and precipitation may be performed in a column reactor, a continuously stirred tank, or other suitable reactor for contacting and reacting an aqueous solution with a solid reactant. In aspects, the contacting of the electrolyte with high metallic feedstock may be performed in a separate reactor or at a separate time relative to contacting the electrolyte with feedstock (or ore) containing minimal or zero metallic iron.

While the high metallic feedstock may itself contain impurity elements such as aluminum, titanium, and phosphorous which may dissolve when contacted with the electrolyte, it is expected that such materials will quickly precipitate as the solution pH rises by dissolution of the metallic iron, thereby causing precipitation of elements deleterious to iron plating.

In some aspects, the high-metallic ore may be provided to a reactor in a quantity of metallic iron sufficient or in excess of that required to (1) convert remaining ferric (Fe³⁺) ions to ferrous (Fe²⁺) ions to reach a total ferric ion concentration in the electrolyte of less than 0.1 mol/l or less than 0.01 mol/l, (2) consume remaining acid, raising the electrolyte pH to at least 3 (or in some aspects to between about 3 and about 4, or in some aspects to between about 3.5 and about 4, or in some aspects up to about 5), and/or (3) cause precipitation of aluminum-containing compounds to a total aluminum concentration in the electrolyte of no more than 0.01 mol/l (or in some aspects, no more than 0.1 mol/l, or in other aspects no more than 0.5 mol/l), phosphorous-containing compounds to a total phosphorous concentration in the electrolyte of no more than 0.01 mol/l (or in some aspects, no more than 0.1 mol/l), and titanium compounds to a total titanium concentration in the electrolyte of no more than 0.01 mol/l.

In some aspects, dissolution or leaching of raw and/or high-magnetite ore may be performed without the use of an acid regeneration cell (e.g., by leaving acid in contact with the ore for about 24 to 72 hours or more), and the resulting leach solution may be reacted with a quantity of high-metallic ore sufficient to convert any ferric iron to the ferrous state. For example, magnetite will dissolve to produce a 2:1 ratio of ferric to ferrous ions. In some aspects, by using high-magnetite ore and high-metallic ore in approximately the same 2:1 ratio, a predominantly ferrous leach solution may be produced without the use of an acid regeneration cell. In some aspects, a resulting predominantly ferrous leach solution may be electroplated to metallic iron in an electroplating cell having an oxygen evolution anode as described herein.

### Re-Concentration of Plating Electrolyte

Another approach to minimizing the costs associated with using metallic iron to adjust pH and composition of the electrolyte prior to electroplating is to extract as much dissolved iron from the iron-treated electrolyte as possible. As described in PCT'712 and Provis'063, and below herein, in some aspects only the portion of electrolyte directed to a plating cell catholyte tank is treated with iron to remove impurities and adjust composition.

However, in some cases, electroplating of iron proceeds most efficiently when the iron concentration in the plating catholyte is within a narrow band. While the precise band of optimal ferrous concentration may depend on structural and operation details of a plating cell configuration, it is generally true that a decreasing concentration of reactant (i.e., Fe²⁺ ions) will lead to a decreasing electrochemical reaction efficiency, meaning more energy is wasted on inefficiency (e.g., resistive losses, parasitic reactions, etc.) as reactant concentration decreases.

If a plating electrolyte with a starting ferrous concentration of 2 M Fe²⁺ ions is used to plate metallic iron only once, and is considered “spent” (and therefore returned to a dissolution subsystem as described) when the ferrous concentration falls to 1.5 M Fe²⁺ ions, then the recycled metallic iron used to “clean up” the remaining electrolyte is effectively wasted as that benefit will be erased when the “spent” electrolyte is mixed with electrolyte dissolving incoming feedstock material. If the “cleaned up” electrolyte may be re-used to plate more iron, then value of the consumed recycled iron may be more completely realized. In some aspects, a second plating cell may be optimized to efficiently plate electrolyte exiting a first plating cell. Similarly, third, fourth, etc. plating cells may also be optimized for plating electrolyte with decreasing ferrous concentrations.

However, a more flexible and less capital-intensive approach may be to re-concentrate “spent” plating electrolyte to a ferrous concentration range within which the first plating operates efficiently. In this way, the benefits of using recycled iron to treat an electrolyte solution may be maximized by re-concentrating the desired reactant (ferrous ions in this case) so as to enable efficient extraction of as much of the ferrous iron as possible. Such re-concentration may be performed as many times as is practical for a given plating cell and/or system size, as each concentration step will decrease the volume of electrolyte available. In some aspects, concentrated electrolyte from two or more parallel systems may be combined to obtain an increased electrolyte volume. Alternatively, a small volume of re-concentrated electrolyte may be mixed with an incoming stream of new plating electrolyte from a dissolution subsystem following an impurity removal step.

Therefore, in some aspects, a plating reaction may be kept within a narrow band of ferrous ion concentration by removing water from the plating catholyte when the ferrous ion concentration falls to a predetermined level (or after a predetermined quantity of metallic iron has been plated from the catholyte). Removing water from the “spent” catholyte will have the effect of increasing ferrous ion concentration while decreasing the volume of electrolyte.

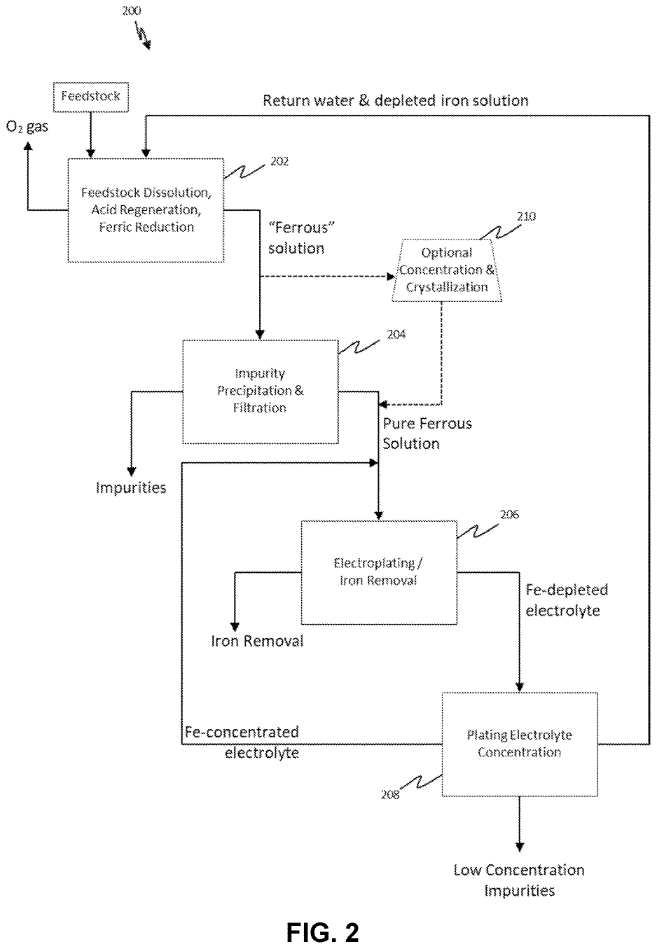

As shown in FIG. 2, following feedstock dissolution 202, at least a “plating catholyte” portion of the electrolyte may be treated in an impurity removal step 204 (e.g., by precipitation and/or filtration as described in PCT'712 and Provis'063 and/or below herein). The “pure ferrous” solution may then be directed to the cathode chamber of a plating cell at 206 where plating and removal of iron may occur. When the ferrous ion concentration of the plating catholyte falls to a predetermined level, the plating catholyte may be directed to a plating electrolyte concentration step 208 in which water is removed, thereby increasing ferrous ion concentration in the plating electrolyte.

In various aspects, the plating catholyte may be directed to a plating electrolyte concentration step 208 after a single pass through a single plating cell. Alternatively, the plating catholyte may be directed to a plating electrolyte concentration step 208 after a single pass through multiple plating cells arranged in fluidic series, or after multiple passes through one or more plating cells. As will be clear to those skilled in the art, a quantity of iron removed from solution by electroplating during a single pass through a given plating cell may depend on many factors such as the plating cell's active area, electrolyte flow rate, electrical current density, electrolyte operating temperature, and other mechanical, electrical, and/or electrochemical parameters.

In various aspects, the plating electrolyte concentration step 208 may be configured to remove enough water to raise the electrolyte's ferrous ion concentration by a target amount. For example, in some cases a plating catholyte may be directed to an electrolyte concentration step when the ferrous ion concentration in the electrolyte is measured to be (or is expected to be based on experience with a particular system) between about 0.5 mol/l and about 1.5 mol/l of dissolved Fe²⁺ ions, and the electrolyte may be concentrated (e.g., by removing water) up to between about 1.0 mol/l and about 3.5 mol/l ferrous ions or up to about the solubility limit of ferrous sulfate (or other ferrous salt) at the operating temperature. In some particular aspects, a plating catholyte may be concentrated from about 1 mol/l ferrous ions to about 1.5 mol/l. In various aspects, the ferrous concentration of the concentrated electrolyte stream from 208 may be equal to or higher than the concentration of the purified electrolyte stream exiting block 204.

In some aspect, water removed from the electrolyte may be used in other parts of the system. For example, in some aspects, all or a portion of removed water may be directed into an anolyte of an acid regenerator as described in PCT'712 and Provis'063. In other aspects, all or a portion of the removed water may be used as a heat transfer medium to cool other parts of the system. In addition to increasing the utilization of treated plating catholyte (i.e., by extracting more metallic iron from it), extracting water from a plating catholyte allows for replacing water consumed in an acid regeneration cell (e.g., by electrolysis, water vapor loss, and/or by electro-osmotic drag into the acid regenerator catholyte).

In various aspects, any available technique may be used to remove and separate water from a concentrated electrolyte. Such techniques may include thermal evaporation, membrane distillation, flash distillation, reverse osmosis, multiple effect evaporation, vapor compression evaporation (including mechanical vapor recompression), or other evaporation and/or distillation techniques. In various aspects, if any part (or all) of an iron feedstock conversion system produces sufficient waste heat, that heat may be captured by a heat exchanger and used to drive an evaporation and/or distillation process for concentrating electrolyte while also cooling the system component(s).

In some aspects, multiple effect evaporation (MEE) may be particularly beneficial in concentrating a “spent” plating electrolyte from a low concentration of ferrous ions to a higher concentration of ferrous ions while removing water from plating electrolyte in an iron feedstock conversion system such as that described in PCT'712 and Provis'063. MEE may be capable of concentrating a spent plating catholyte enough to replace water lost from the acid regeneration anolyte under some conditions.

MEE is a well-known apparatus and method for efficiently using the heat from steam to evaporate water. Water is boiled in a sequence of vessels, each held at a lower pressure than the previous vessel. Because the boiling temperature of water decreases as pressure decreases, the vapor boiled off in one vessel can be used to heat the next vessel in the sequence. In some cases, the first vessel may be heated using waste heat or other heat sources. Alternatively, the first vessel may be operated at a pressure below ambient to boil at the electrolyte operating temperature.

In an iron conversion system such as that described in PCT'712 and Provis'063, both the acid regeneration cell(s) and the plating cell(s) will tend to produce more heat than is needed to maintain the desired operating temperatures of those cells. As a result, such “waste” heat may be removed from those cells/stacks by a heat transfer medium (e.g., a liquid such as water or a gas), and the waste heat may be transferred to the first evaporation vessel of an MEE system to provide additional heat to boil the “spent” electrolyte in the first vessel. Electrolyte may then be directed into a second vessel, and optionally a third vessel before concentrate is returned to a plating catholyte system (e.g., a plating catholyte tank or a plating cell as described in PCT'712 and Provis'063). Alternatively, the electrolyte may be evaporated directly, by boiling it. In some aspects, condensing vapor in the final stage of an MEE system may call for cooling, such as through use of cooling towers (either directly or through a heat exchange medium).

In some aspects, a combination of two or more evaporation or distillation techniques may be used to concentrate a plating electrolyte. For example, in some aspects, a mechanical vapor recompression (MVR) system may be used in series with an MEE system. Mechanical vapor recompression is a well-known evaporation/distillation system involving optionally pre-heating (e.g., using waste heat and/or heat extracted from condensate exiting the MVR system) and pumping a feed liquid input stream (e.g., the electrolyte to be concentrated) into a liquid/gas separation vessel (e.g., a tube-side of a shell-and-tube heat exchanger, or other vessel) in which water vapor is separated from liquid (e.g., electrolyte). The vapor is then mechanically compressed by a compressor, which heats the gas to a higher temperature while also increasing its condensation temperature. The heated and compressed vapor is then directed to the shell side of a shell-and-tube heat exchanger where it is condensed to liquid, giving up its heat which is captured to evaporate water from the electrolyte feed stream. The compressed vapor may be condensed to liquid water and removed from the system (and further cooled if needed), and the concentrated electrolyte may be removed. The MVR system may be sized or cycled as needed to achieve a desired degree of water extraction and electrolyte concentration. In various aspects, any suitable vessels, heat exchangers, or other apparatus may be used for liquid/gas separation, condensation, and heat exchange in an MVR system.

In some aspects, a plating catholyte may be first directed through an MVR evaporation system, followed by an MEE system. In other aspects, a plating catholyte may be first directed through an MEE system followed by an MVR system.

As shown in FIG. 2, so-called “low concentration” impurities may also be removed from the plating electrolyte concentration step 208. As used herein, the term “low concentration” impurities refers to impurity elements that exist in relatively low quantities in the feedstock materials, and therefore exist in the electrolyte in low concentrations upon dissolution of the feedstock. If such elements are not removed during an electrolyte treatment with metallic iron, they will be passed along to the plating catholyte, and will be concentrated along with ferrous ions when “spent” plating catholyte is concentrated as described herein. This fact may be beneficially leveraged to remove the low-concentration impurities by “bleeding” a small stream of the concentrated plating electrolyte once the concentration of such “low concentration” impurities rises to a level at which they can be precipitated by a pH swing or a temperature swing, or otherwise removed. Using a bleed stream from the concentrated plating electrolyte allows for consistent removal of “low concentration” impurities without losing unacceptable quantities of iron or supporting electrolyte salts. In some aspects, a proportion of the concentrated electrolyte diverted to a “bleed stream” precipitation step (or other impurity removal step) may be between about 0.5% and about 5% of the concentrated electrolyte. In some particular aspects, the proportion may be about 0.5%, 1%, 1.5%, 2%, 3%, 4%, or 5%.

### Ferrous Sulfate Crystallization

In other aspects, any of the above evaporation/distillation processes may be used to concentrate (remove water from) the “ferrous” solution exiting the feedstock dissolution subsystem 202 in an optional step of “concentration and crystallization” 210. Using techniques such as the combination of MVR and MEE (or other techniques) as described above, the concentrated stream may be evaporated to a concentration above the solubility limit of ferrous sulfate, or cooled to a temperature below the solubility limit of ferrous sulfate, or both. As a result of the concentration increase or decrease in temperature, ferrous sulfate (FeSO₄) will tend to crystallize out of the solution without necessarily precipitating any of the impurities. If desired, the temperature of an evaporation operation may be reduced below the boiling point of the electrolyte by operating under vacuum. The concentrated solution may then be directed to the Impurity Precipitation and Filtration step 204. The ferrous sulfate crystals may be re-dissolved in the Pure Ferrous Solution exiting the Impurity Precipitation and Filtration step 204, thereby further increasing concentration of the plating electrolyte prior to electroplating in step 206.

### Purifying Electroplating Cell

Another approach to minimizing the costs associated with using metallic iron to adjust pH and composition of the electrolyte prior to electroplating is to use a different method for extracting some or all of the impurities most deleterious to iron plating. These predominantly include aluminum, titanium, and phosphorous compounds which, if present in a plating catholyte during plating, tend to precipitate due to localized pH shift in the electrolyte at or near the surface of a plating cathode. This can cause poor adhesion of the iron plated onto the cathode, which can complicate efficient removal of iron from the plating cell. However, this phenomenon may be leveraged as a method of removing these deleterious impurities without consuming additional reactants such as metallic iron or aqueous base solutions.

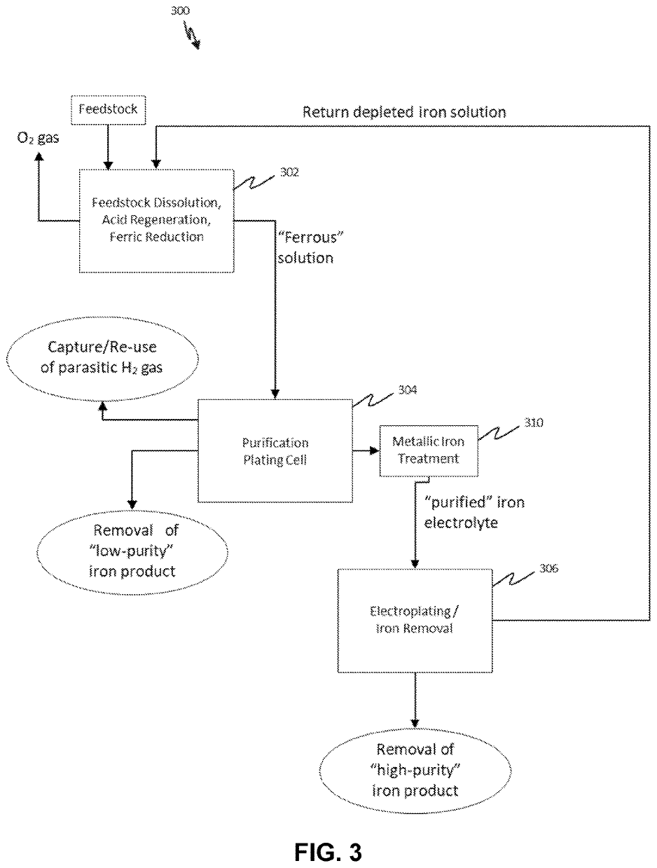

As shown in FIG. 3, in some aspects an iron feedstock conversion system 300 may comprise a purification plating cell 304 may be used to intentionally cause precipitation of the deleterious impurities while electroplating some iron. In various aspects, a purification plating cell cathode may be configured to support reduction of ferric iron to ferrous iron, and ferrous iron to metallic iron. In some aspects, the purification plating cell anode may be configured to oxidize ferrous iron to ferric iron as in some iron plating cells of types described in PCT'712 and Provis'063 and/or below herein. Alternatively, the purification plating cell anode may be configured to oxidize water and evolve oxygen gas from a water or acid anolyte.

In some aspects, the impurities and iron plated in the purification plating cell 304 may be removed as a “low-purity” iron product, which may be used or sold either for its iron content or its content of one or more of the impurities (e.g., aluminum phosphate and iron phosphate may be used as a fertilizer additive, and aluminum hydroxide or alumina may be used for aluminum metal production). In some aspects, purification plating cells may be configured with a different construction and/or operated differently than iron electroplating and removal cells 306 used for producing a high-purity iron product.

While in some aspects, purification plating cells may be configured substantially the same as a plating cell configured to produce a high-purity iron product (e.g., the plating cells described in PCT'712 and Provis'063 and/or below herein), in other aspects, purification plating cells may be designed, constructed, and/or operated differently. In some aspects, purification plating cells may be configured to electrolytically produce metallic iron as a powder by operating the cell at a current density of at least 1 A/cm².

In some such aspects, the plating cathode chamber may be configured for removal of the produced iron powder along with precipitated deleterious impurities. For example, the plating cathode chamber may comprise a basket, tray, or pocket configured to catch iron particles and impurity particles as they settle in the cathode chamber. In some aspects, a purification plating cell may be configured to incorporate a fluidized bed reactor, a spouted bed reactor, a conical spouted bed reactor, or other suitable reactor to collect and separate produced iron powder and precipitated impurities from the electrolyte.

In some aspects, the iron particles may be separated from the non-iron particles by magnetic separation or by other methods (e.g., aluminum may be substantially isolated by dissolving a mixture of powders/particles in a base solution in which relatively little iron will tend to dissolve).

In other aspects, an impurity plating cell may be configured with a highly porous or compartmented three-dimensional cathode of an acid-insoluble material such as titanium or graphite. In some aspects, such a three-dimensional impurity-collecting cathode may comprise a foam material, a three-dimensional honeycomb, or a “pocket-plate” structure such as those used in some batteries including some nickel-iron batteries. In such aspects, iron may be plated on conductive surfaces within the three-dimensional structure of the cathode, while precipitated impurities may be loosely trapped within the cavities. Upon removal, these impurity-collecting cathodes may be rinsed in water (or a base solution) to remove some of the impurities, and the remaining impurity-collecting cathodes may be used in a metallic iron treatment 310 for consuming excess acid and ferric iron from a “ferrous” solution exiting a feedstock dissolution and acid regeneration step 302. Using a purification plating cell to remove impurities may tend to decrease the quantity of metallic iron needed to consume remaining acid and reduce remaining ferric ions.

In other aspects, the purifying plating cell 304 may be operated to form iron plates, large particles, or continuous iron strips.

In some aspects, electroplated iron and precipitates may be left in the purifying plating cell such that, on a subsequent purifying plating cycle, the new impurity-containing electrolyte contacts the previously-plated metallic iron, and a portion of the impurities in the new impurity-containing electrolyte precipitates prior to beginning a new impurity-removal plating cycle.

If excess acid is not removed prior to directing the ferrous solution to the purification plating cell, hydrogen evolution will be thermodynamically preferable to iron plating at the purification plating cell cathode, and this side reaction may tend to occur throughout operation of the purification plating cell. In such cases, this “parasitic” hydrogen may be captured and re-used in other parts of the iron feedstock conversion system as described in various examples and aspects in PCT'712 and Provis'063.

Once the deleterious impurities have been adequately removed, the “purified” ferrous electrolyte may be directed to the electroplating cell 306 from which a “high purity” iron product may be removed.

### Accessory Iron Treatment

In some aspects, all or a portion of an iron-rich acid solution at the completion of a dissolution process may be directed to a reaction vessel in which an “accessory iron treatment” process may be performed. Depending on the condition of the iron-rich acid solution at the end of dissolution and the desired condition of a solution to be delivered to a plating subsystem, one or more of three possible reactions may occur: acid consumption, ferric reduction, and/or impurity precipitation.

Metallic iron used for the purpose of reacting with or otherwise modifying the composition of an iron-rich acid solution is referred to herein as “accessory iron” and may include any material comprising metallic iron in particles of sufficiently small size to promote desired reactions with the solution. Accessory iron materials may include, but are not limited to scrap steel, scrap iron, iron dust (e.g., fine particulate iron-containing dust from other industrial processes), pig iron, electrolytic iron, iron produced by reduction of hematite and/or magnetite ore (e.g., direct reduced iron or “DRI”), or iron recycled from any iron conversion process described herein (or other processes), or combinations of these or other metallic-iron-containing materials. The accessory iron materials may be any particle size, but smaller particles may generally be capable of faster reaction rates. However, even relatively large particles (e.g., larger than 2 cm) may be used as “accessory iron” in some aspects.

When an iron-rich acid solution is contacted with metallic iron, any remaining acid will tend to react with the metallic iron to convert the metallic iron into ferrous (Fe²⁺) ions while releasing hydrogen gas according to:

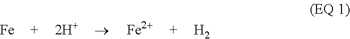

Therefore, in some aspects, the accessory iron reaction vessel (e.g., a tank or other vessel in which the solution may be contacted with the accessory iron) may be configured as a closed vessel from which evolved hydrogen gas may be collected and directed to another process or sub-system as described elsewhere herein.

In some aspects, any remaining Fe³⁺ ions present in the iron-rich acid solution at the completion of a dissolution process may be reduced to Fe²⁺ by exposing the Fe³⁺ ions to metallic iron which will be dissolved and will react with the ferric ions to convert both into ferrous ions. For example. Fe³⁺ may be reduced to Fe²⁺ by flowing a mostly-ferrous solution over or through a quantity of metallic iron particles (“accessory iron”). This will have the effect of converting some of the metallic iron and Fe³⁺ to Fe²⁺ in solution according to the equation:

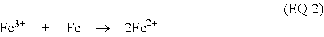

Advantageously, these two reactions (acid consumption and ferric reduction) will increase the efficiency of the iron plating in the plating subsystem both by decreasing (or potentially eliminating) Fe³⁺ as well as by decreasing the occurrence of the parasitic hydrogen evolution reaction during iron plating.

In some aspects, excess acid and ferric ions may be consumed in a separate electrochemical cell (“polishing cell”) configured to electrolytically convert remaining Fe³⁺ to Fe²⁺ and raise pH of catholyte by consuming acid. Such a cell may allow for decoupling of impurity removal from the process of consuming excess acid and ferric. In some aspects, a polishing cell may be configured substantially similarly to a plating cell, but without the need to provide for removal of metallic iron. In some aspects, a polishing cell may be configured to cause H₂ evolution without any electroplating and using precious metal electrodes such as Pt at the cell cathode.

### Removal of Impurities

Some impurities, including kaolinite and other silicate minerals are generally insoluble in the acid solution produced in the acid-regeneration cell. Therefore, when ores or other feedstocks containing such insoluble impurities are ground to small particles and placed in a dissolution tank connected to an acid regeneration cell, the insoluble impurities may be filtered out of the solution, collected at the bottom of the tank and removed from the tank as solids, or removed by any other suitable solid-liquid separation technique or apparatus. In various aspects, the collected solid impurities may be treated and disposed of or used in other processes for which the “impurities” may be feedstocks.

Some solid impurities, including some forms of amorphous silica, may tend to form a colloidal dispersion in the acid solution. Such materials may be separated from the solution by flocculation with a flocculant such as polyethylene glycol or polyethylene oxide. Nonetheless, some silica may remain dissolved.

Some impurities may form relatively low-solubility compounds with iron or other materials in solution. The term “solubility” refers to the compound's thermodynamic solubility limit in a given solution, which is the concentration limit above which the compound will begin to precipitate out of solution as a solid.

Significant soluble impurities include compounds of aluminum, silicon, titanium and phosphorous among others. Aluminum compounds dissolve to form Al³⁺ cations, and phosphorus may typically dissolve to form phosphate PO₄³⁻. These impurities can pose various problems for downstream processes such as pumping, filtration, acid regeneration, iron plating, etc. Aluminum impurities may exist in iron ores in amounts up to about 10 weight percent of the unprocessed ore. While phosphorous tends to exist in much smaller amounts (e.g., typically less than 1%, but can be more), even small amounts of phosphorous must be removed prior to steel-making processes, and therefore is undesirable in plated iron produced by the plating cell. In particular, aluminum and phosphorous impurities have been found to interfere with iron electroplating processes.

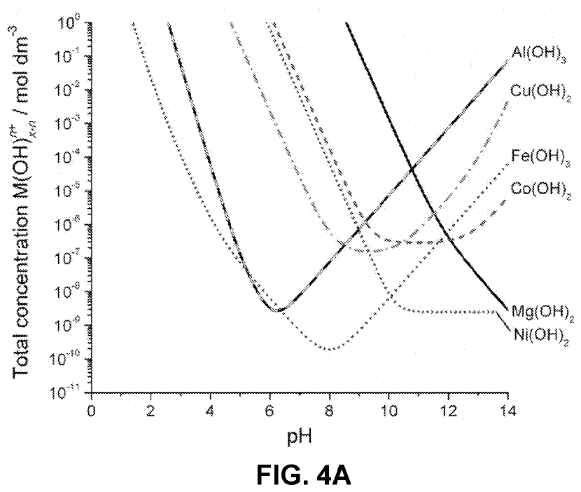

As shown in FIG. 4A, the solubility of aluminum hydroxide decreases significantly as pH increases above 3 (e.g., 6 orders of magnitude solubility drop between pH 3 and 5). While not shown, iron (II) hydroxide (Fe(OH)₂, or “ferrous” hydroxide) has a higher solubility in this pH range. This suggests that aluminum hydroxide (Al(OH)₃) may be precipitated without substantial precipitation of iron ions by raising the pH above 3 until about 5 (e.g., from a pH of about 1 or 2 at the end of dissolution). Similarly, phosphates of iron or aluminum may also be precipitated without necessarily precipitating substantial quantities of iron for similar reasons. In some cases, colloidal silica may also be removed by raising the solution pH (e.g., by flocculation along with precipitation of other species). Titanium hydroxide, if present will also precipitate in a similar pH range, and may also be separated and removed from the solution. In some aspects, pH may be increased, for impurity removal, with the use of a different base (i.e., other than or in addition to metallic iron) such as calcium hydroxide, magnesium hydroxide, sodium hydroxide, potassium hydroxide, iron (II and/or III) hydroxide, aluminum hydroxide, or other solid soluble base materials. Alternatively or in addition, a pH may be increased for impurity removal with the use of an aqueous solution containing one or more dissolved bases such as those described above or others.

It is frequently desirable to raise the pH of the dissolved-ore solution without adding new elements into solution (as any such new elements may further affect and/or complicate other processes). Therefore, in some aspects, metallic “accessory iron” may be used to raise the solution pH sufficiently to precipitate these impurities.

As the pH rises with additional consumption of accessory iron (i.e., by reacting with acid to form hydrogen gas), phosphorus will tend to precipitate predominantly as an aluminum phosphate salt, so iron is not necessarily consumed when removing phosphorous.

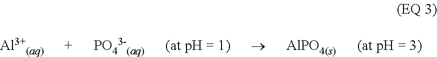

For the metal cations like aluminum, iron displaces the cation in solution to precipitate the metal as a hydroxide. In a system designed for producing substantially pure iron, the quantity of an impurity may be expressed in terms of the molar ratio of the impurity to iron. For example, for each mole of aluminum to be removed, 1.5 moles of accessory iron must be used according to equation 4 (using sulfuric acid as a non-limiting example):

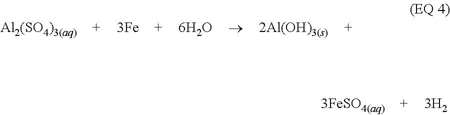

Water is consumed and hydrogen gas is generated by this reaction. The removed protons were acidic due to hydrolysis from the cation (equation 5 below). In some cases, at least a portion of the evolved hydrogen gas may be collected and used in another process within the system as described herein.

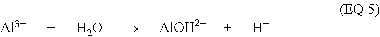

In some cases, it may be beneficial to remove impurities by iron addition only to the portion of the iron-rich acidic solution to be used for iron electroplating (i.e., the portion of the solution to be used as plating catholyte). Therefore, in the case in which an acid regenerator is used and electrolyte is divided into two portions for the electroplating step, only the portion designated as the plating cell catholyte (e.g., about ⅓ of the electrolyte exiting the acid regenerator) may be treated by addition of accessory iron metal.

As metallic iron is dissolved in the solution, it will also convert any dissolved ferric iron (Fe³⁺) to ferrous iron (Fe²⁺). For example, 0.5 mole of metallic iron will be consumed for each mole of ferric sulfate converted to ferrous sulfate according to Equation EQ 6 (as an example with a sulfuric acid case):

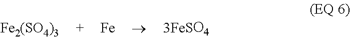

Dissolved metallic iron can also consume remaining acid in the treated electrolyte in a 1-to-1 molar ratio according to Equation EQ 7:

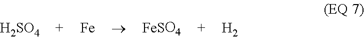

Therefore, a quantity of accessory iron to be added to a quantity of electrolyte may be determined based on measured, estimated, or assumed quantities of impurities (e.g., aluminum and/or phosphorous in particular), remaining ferric ions, and remaining acid. It may be beneficial to expose the electrolyte to excess accessory iron (i.e., more metallic iron than is required to achieve the reactions of Equations EQ 4, EQ 5, EQ 126 EQ 7, so that some metallic iron remains after those reactions have proceeded as far as they will). If needed, accessory iron can be separated from the precipitated impurities through any of a variety of separation methods, including flotation, filtration and magnetic separation. Similarly, the precipitated impurities may be removed from the solution by any suitable solid-liquid separation devices or techniques. In some aspects, the treated solution may be pumped out of the vessel where the impurity removal (and/or accessory iron) treatment is performed, leaving iron metal and precipitated impurities in the tank for the next treatment cycle.

Even if aluminum is not present, phosphorous may be effectively removed by precipitation of iron phosphates as suggested by the solubility diagram in FIG. 4B and FIG. 4C which shows solubility of various iron phosphate and oxide compounds. At the beginning of the treatment phase, there is always a residual ferric concentration. As seen in FIG. 4C, ferric phosphate has very low solubility and hence, as soon as pH increases due to reaction in EQ. 1, iron phosphate will precipitate out of the solution.

Various other methods of managing or removing impurities may be used depending on the type of impurity. For example, insoluble impurities may simply be removed as solids by filtration, gravity, centrifugal separation, or other mechanical separation. Soluble impurities that could interfere with iron plating may be removed by forming compounds with other materials such as iron (including during an “accessory iron” treatment), aluminum, or may simply be allowed to deposit along with the iron if the concentration of such impurities in the final plated material is acceptable (which may depend on the particular product or end use of a produced iron material).

Soluble impurities that are harmless to plating may be simply left in solution. Eventually, concentrations of such impurities may build up to a point that they can be removed by extracting water. Alternatively, infrequent impurities may eventually build up in concentration (e.g., over enough dissolution and plating cycles) sufficiently to be removed by precipitation due to a pH shift or by other methods. In still other aspects, an electrolyte solution may simply be replaced when such impurities build to sufficient levels.

According to some aspects herein, an impurity removal step, such as where metallic iron is added, may be performed at an elevated temperature, such as, but not necessarily limited to, 80° C.±5° C., optionally at any temperature or within any range of temperatures selected from the range of approximately 50° C. to approximately 90° C. In aspects, the elevated temperature, such as approximately 80° C.±5° C., substantially increases filtration rates, such as 3x to 4x, and reduces the amount of metallic iron trapped in the resulting filter cake, for example, from 2:1 Fe to Al at 60° C. to 1:2 Fe to Al at 80° C. in the filter cake.

### Pre-Treatment of Iron Feedstock to Aid Dissolution

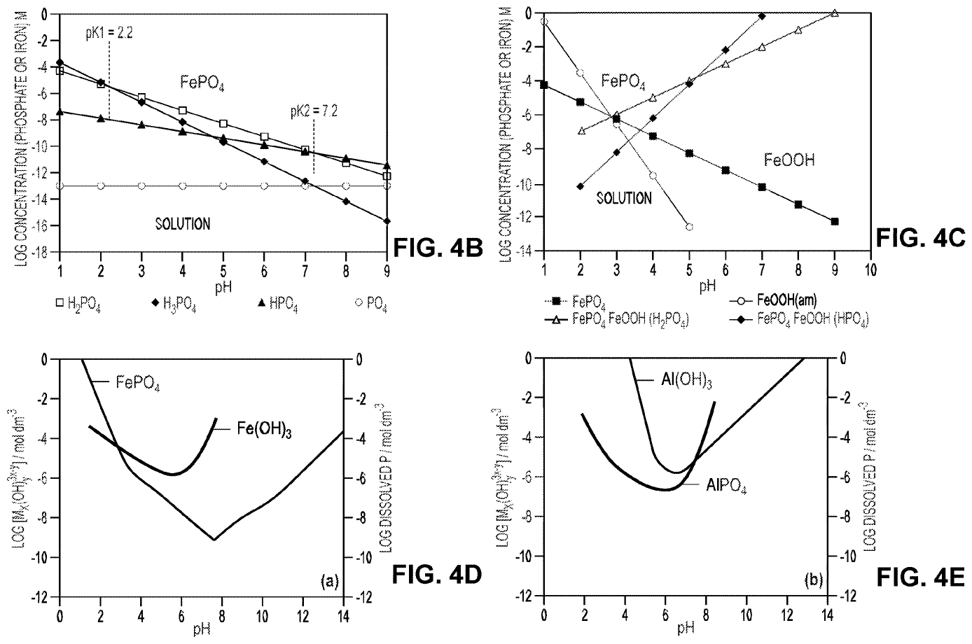

FIG. 5 provides a very high-level schematic illustration of an iron conversion system 100 according to some aspects. The diagram of FIG. 5 shows a pre-treatment section 920, a dissolution subsystem 102 comprising a dissolution section 908, an acid regeneration section 910 (each of which is described above), and a plating section 130 from which iron may be removed 922. Oxygen may be evolved from the acid regeneration section 910, and hydrogen may be evolved from the plating section 130 and/or from the impurity treatment section 918 between the acid regeneration 910 and plating 130 sections. Evolved hydrogen may be returned to a pre-treatment section 920 for use in some pre-treatments. Additional impurity removal steps (e.g., removing solid impurities, organic impurities, undissolved solids, or other impurities) 914 and 916 between the pre-treatment section 920 and the dissolution subsystem 102. As illustrated in FIG. 5, for example, goethite and hematite may be thermally reduced to magnetite, optionally where the reductant is H₂ gas evolved during plating. As illustrated in FIG. 5, for example, impurities may be removed at various stages of the process, such as in the dissolution subsystem (e.g., between the dissolution and acid regenerator (first electrochemical cell) and/or such as between the dissolution subsystem and the iron-plating subsystem.

As illustrated, prior to a dissolution subsystem 102, iron feedstocks and particularly some iron ores may be treated or modified in order to facilitate dissolution. In some aspects, goethite ores 902 may be converted into hematite ores 904, which may be converted into magnetite ores 906. In other aspects, some portions of ore may be kept in a goethite or hematite form.

Iron feedstock materials may contain iron or iron oxides in one or more of many possible forms, including steel, scrap steel (or scrap iron) mixed with other metals and non-metals, metallic iron of various purities, or iron oxides (including hydroxides and oxyhydroxides). However, some iron oxides commonly present in iron-containing ores dissolve relatively slowly. The following paragraphs pertain to improvements to the dissolution of iron-containing ores.

Different iron oxides have different dissolution kinetics. For example, magnetite (Fe₃O₄, which contains both Fe³⁺ and Fe²⁺) dissolves much more readily than oxides containing only Fe³⁺ such as hematite (Fe₂O₃) and goethite (FeO(OH)). The difference in dissolution kinetics can be as much as 40 times between hematite and magnetite, for example. Many commercially available and economically viable iron ores contain large quantities of hematite and/or goethite. Optional aspects herein include converting at least a portion of iron oxides such as hematite and/or geothite in iron-containing ore into magnetite for the benefit of faster dissolution. Conversion to magnetite may also provide the advantage of allowing for magnetic separation of magnetite-containing materials from less-magnetic forms of iron prior to dissolution in acid. Processing feedstock ore to convert certain iron oxides to magnetite is an optional aspect that may be advantageous for some applications, but is not necessary for the operation of the methods disclosed herein.

In other cases, it has been found that merely heating some hematite or goethite ores to sufficient temperatures even in an air atmosphere (i.e., “air roasting”) may cause sufficient morphological change to the ore structures to allow for acid dissolution of those “roasted” ores within an acceptable timeframe (e.g., on the order of about 24 hours+/−6 hours), particularly when dissolution is coupled with an acid regeneration cell 104 as described herein. In some cases, even entirely untreated “raw” ores may be dissolved in acceptable timeframes when coupling dissolution with an acid regeneration cell 104.

Geothite can be converted to hematite by roasting in air at a temperature between about 200° C. and 600° C., and hematite can be thermally reduced to magnetite in hydrogen at a temperature of between 300° C. and 600° C.

In various aspects, “air roasting” may be performed by heating ore in an air atmosphere to a temperature of between about 200° C. and 600° C. for a duration of about 1 minute to about one hour. In some particular aspects air roasting may comprise heating ore to a temperature of about 200° C. to about 400° C. In various aspects, air roasting of ore may include ramp-up time to achieve the target temperature from a starting temperature (e.g., ambient or room temperature). In some aspects, a time duration of air roasting may begin when the ore material reaches a first target temperature.

In various aspects, “thermal reduction” may be performed by heating ore in a reducing atmosphere to a temperature of between about 300° C. and 600° C. for a duration of about 1 minute up to about 5 hours, depending on the extent of reduction required and morphology of materials to be reduced. In some aspects, the reducing atmosphere may comprise a gas mixture of about 1% to about 10% hydrogen gas (or other reducing gas) with a balance of an inert gas such as nitrogen, argon or other inert gas. In some aspects, much higher hydrogen content gas mixes, even close to 100% H₂, may be used. In some aspects, a thermal reduction atmosphere may also be humidified to contain about 5% to about 10% water vapor.

In some particular aspects thermal reduction may comprise holding ore at a temperature of about 300° C. to about 500° C., in some specific aspects to a temperature of about 375° C., 400° C., 425° C., 450° C., 500° C., 525° C., 550° C., or more. In various aspects, when thermally reducing ore, the ore may be exposed to an air (or other non-reducing) atmosphere during a ramp-up time until a target temperature is reached, so as to conserve hydrogen gas that may be ineffective before reaching the target temperature. In some aspects, a time duration of thermal reduction may begin when the ore material reaches a first target temperature.

In some aspects, it may be desirable to stop thermal reduction of iron ore before complete reduction to iron metal, such as by removing the ore, decreasing the temperature, or maintaining a sufficient humidity level to prevent reduction to iron metal. In other aspects, a portion of the ore may be allowed to reduce to iron metal before proceeding to a dissolution step.

Hematite can be reduced to magnetite using a reductant such as hydrogen, carbon monoxide, syngas, etc. This can be done for many different purposes, particularly for iron beneficiation using magnetic separation. It is contemplated herein that iron-making processes such as electroplating can involve generating a reductant, such as hydrogen, optionally as a side reaction (e.g., via a parasitic reaction or during iron plating) or as a direct result of an intermediate process step (e.g., an “accessory iron treatment” step as described herein).

Reductants, such as hydrogen produced by parasitic or incidental reactions, instead of being wasted, can be captured and used to reduce iron oxides such as hematite and goethite in ore to magnetite. As a result, some of the energy “wasted” by generating a reductant as a byproduct in a different process (e.g., hydrogen from electroplating or other process) can be thus recovered, and concurrently the reduced ore becomes much easier to dissolve.

Generally, according to certain aspects, at least a portion of the reductant, such as H₂, may be a product of any portion, step, or reaction of a process for making iron.

According to certain aspects, the reductant, such as H₂, may be generated prior to and/or external to an iron electroplating process, or electrochemical cells thereof. H₂ generation may occur during an electroplating process when, for example, the pH is low (e.g., too much residual acid in an input stream delivered to an electroplating cell), resulting in a reduction of Faradaic efficiency of the electroplating which allows for a side reaction (or, parasitic reaction) that generates H₂ concurrently with iron electroplating. Hence, when the plating starts, there may be significant H₂ generation until the pH increases to about 2 (or other value, depending on the acid chemistry used). In some aspects, a plating cell or a similarly-configured polishing cell may be configured to allow for collection and storage of the hydrogen gas generated during such operations.

According to certain aspects, systems and methods disclosed herein can include a combination of the above approaches as a solution to improve iron dissolution in acids. According to certain aspects, methods disclosed herein can include use of a product of a side reaction (such as hydrogen), or byproduct, in the iron making process for the conversion of non-magnetite iron ore, or non-magnetite iron oxide compounds in an iron-containing ore, into magnetite to enhance dissolution kinetics. According to certain aspects, methods disclosed herein can include the combination (i) reduction of iron oxide (e.g., an oxide ore) to magnetite with (ii) dissolution of the resulting material (magnetite) using acid.

According to certain aspects, methods disclosed herein can include starting material being an iron-containing ore (e.g., ore, iron ore, rock, sediment, minerals). According to certain aspects, methods disclosed herein can include the reductant (for converting non-magnetite iron oxides to magnetite) being a byproduct of another reaction step in the overall iron making process. According to certain aspects, methods disclosed herein can include reductant (for converting non-magnetite iron oxides to magnetite) generation from a combination of the internal source (e.g., from the byproduct of the overall iron making process) and from an external source, including from a hydrogen storage, a natural gas reforming system providing hydrogen gas, or a water electrolyzer. According to certain aspects, methods disclosed herein can include the reductant (for converting non-magnetite iron oxides to magnetite) being hydrogen, carbon monoxide, natural gas, syngas or a combination thereof. According to certain aspects, methods disclosed herein can include using a byproduct of an electrochemical plating reaction to drive a different reaction such as using hydrogen byproduct to reduce iron oxides. The byproduct can be generated directly at the plating cell or prior to the plating cell in a separate reactor with a similar net production of hydrogen gas.

According to certain aspects, included herein is a method for dissolving iron-containing iron ore having one or more non-magnetite iron oxide materials, the method comprising: exposing the iron ore to a reductant at a temperature between 200° C. and 600° C. and converting at least a portion of the iron oxides in the ore to magnetite, thereby forming a processed ore, and dissolving the processed ore using an acid to form an iron salt solution. Optionally, the reductant is the byproduct of another reaction in an iron making process.

In various aspects, systems and methods herein may be configured to dissolve quantities of differently-treated iron-containing ore materials in order to achieve a desired target dissolved iron concentration within an acceptable time duration (e.g., within about 24 or 30 hours). Overall, as described herein, dissolution of iron oxide was found to be substantially improved in the presence of ferrous ions and in the presence of sufficient acid as created by the acid regenerator. Nonetheless, reduction of hematite ores to magnetite showed substantial improvement in dissolution rates and completeness in any environment.

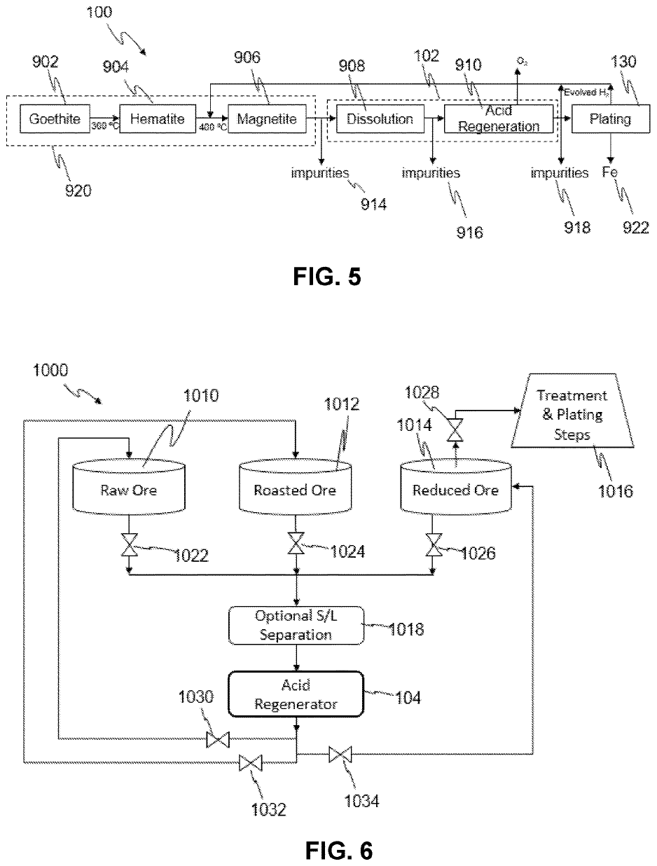

As illustrated in FIG. 6, a dissolution subsystem 1000 may comprise an acid regenerator 104 coupled to a plurality of ore-containing dissolution tanks 1010, 1012, 1014 (or more or fewer in other aspects). As shown, each tank may contain a differently-processed ore material. For example, a first tank 1010 may contain “raw” ore that has not been thermally pre-treated. Such raw ore may contain goethite and/or other ore types. A second tank 1012 may contain ore that has been “roasted” as described above, for example air-roasting, and may contain hematite and/or other ore types. A third tank 1014 may contain thermally-reduced ore as described above, and may contain substantial quantities of magnetite and other ore types.

Reduced ore dissolves very quickly reaching complete dissolution in a matter of hours, and roasted ore dissolves much more slowly, although dissolution rate may be increased somewhat by increasing temperature and/or the quantity of ferrous ions in solution. Raw ore has been shown to dissolve more slowly than roasted ore.

The system of FIG. 6 illustrates several possible processes that may be applied to selectively direct an acid-enhanced dissolution solution from an acid regenerator 104 to one or more of the dissolution tanks 1010, 1012, 1014. For the purposes of explanation, a process will be described during which the acid solution will be recirculated for one ten (10) cycles between the acid regenerator 104 and one or more of the tanks 1010, 1012, 1014, where each cycle begins at the exit of the acid regenerator 104. While 10 cycles are described in this example, any number of cycles may be used, depending on various details of a particular implementation. In other cases, “cycles” may simply represent relative time periods during which the solution is contacted with each of the ore types, and different arrangements of tanks, fluid conduits, valves, etc. may be used. For example, instead of changing where fluid is directed, the solid contents of a single dissolution tank may be changed for various amounts of time approximately corresponding to the number of cycles described in the example below.

During a first group of the 10 cycles, the acid solution may be directed to the raw ore tank 1010 by opening the valve 1030. The acid solution exiting the raw ore tank 1010 may be returned to the acid regeneration cell 104 by opening the valve 1022. During a second group of the 10 cycles, the acid solution may be directed to the roasted ore tank 1012 by opening the valve 1032. The acid solution exiting the roasted ore tank 1012 may be returned to the acid regeneration cell 104 by opening the valve 1024. In some aspects, during a third group of the 10 cycles, the acid solution may be directed to the reduced ore tank 1014 by opening the valve 1034. The acid solution exiting the roasted ore tank 1014 may be returned to the acid regeneration cell 104 by opening the valve 1026, or may instead (or in addition) be directed to down-stream processes 1016 (e.g., impurity removal, accessory iron treatment, plating, etc.) by opening the valve 1028.

Therefore, by changing the number of “cycles” through each dissolution tank, the acid solution may be contacted with the differently-treated ores for different amounts of time. In various examples, the acid solution may be contacted with the raw ore 1010 for 0 to 9 of the cycles, with the roasted ore 1012 for 0 to 9 of the cycles, and with the reduced ore 1014 for 1 to 10 of the cycles. It is generally desirable to contact the acid solution with the reduced ore 1014 for at least the final cycle before directing the solution to downstream process steps 1016. Because dissolution of reduced ore proceeds relatively quickly, finishing the dissolution process with the reduced ore serves to consume some of the remaining acid, further simplifying downstream steps as described elsewhere herein.

Any of the combination of cycles (or proportional residence time) in Table 1 below may be used:

TABLE 1
Options for Dissolution of Differently-Treated Iron Ores
Number of Acid “Cycles” on Each Ore Treatment Type

| | | | | | | | | | | | | | | | | | | | | | | | | | | | | |
|---|---|---|---|---|---|---|---|---|---|---|---|---|---|---|---|---|---|---|---|---|---|---|---|---|---|---|---|---|
| Raw | 0 | 0 | 0 | 0 | 0 | 0 | 0 | 0 | 0 | 0 | 0 | 1 | 2 | 3 | 4 | 5 | 6 | 7 | 8 | 1 | 2 | 3 | 4 | 5 | 6 | 7 | 8 | 9 |
| Roasted | 9 | 8 | 7 | 6 | 5 | 4 | 3 | 2 | 1 | 0 | 9 | 8 | 7 | 6 | 5 | 4 | 3 | 2 | 1 | 0 | 0 | 0 | 0 | 0 | 0 | 0 | 0 | 0 |
| Reduced | 1 | 2 | 3 | 4 | 5 | 6 | 7 | 8 | 9 | 10 | 1 | 1 | 1 | 1 | 1 | 1 | 1 | 1 | 1 | 9 | 8 | 7 | 6 | 5 | 4 | 3 | 2 | 1 |

In some aspects, a method may comprise dissolving an iron feedstock in an acid; producing metallic iron by evolving oxygen gas from water at an anode of an electrochemical cell while electroplating metallic iron from a ferric iron solution at a cathode of an electrochemical cell or during a treatment step, and evolving hydrogen in a side-reaction at the cathode of the electrochemical cell, collecting the hydrogen, transferring the hydrogen to a reaction chamber, and thermally reducing the iron feedstock in the reaction chamber with the hydrogen.

In some aspects, a method may comprise dissolving an iron feedstock in an aqueous acid solution in a dissolution tank; circulating the solution from the dissolution tank to an acid regeneration cell; converting ferric ions in the solution to ferrous ions at a cathode of the acid regeneration cell while evolving oxygen from water at the anode of the acid regeneration cell; transferring a first portion (anolyte) of the solution to an anolyte tank of an iron plating system; transferring a second portion (catholyte) of the solution to a catholyte tank of the iron plating system, optionally including a treatment step to remove impurities and to create H₂; circulating the anolyte and catholyte between their respective tanks and an iron plating cell; oxidizing ferrous iron to ferric iron in the anolyte at the anode of the plating cell while electroplating metallic iron from ferrous iron in the catholyte at the cathode of the plating cell and while evolving parasitic hydrogen at the cathode during electroplating and/or optionally using H₂ generated from the treatment step to remove impurities and to create H₂; collecting the hydrogen and transferring the hydrogen to a reaction chamber, and thermally reducing the iron feedstock in the reaction chamber with the hydrogen.

In some aspects, a method may comprise producing hydrogen by mixing an aqueous acidic solution with metallic iron, collecting the hydrogen, transferring the hydrogen to a reaction chamber, and thermally reducing iron feedstock in the reaction chamber with the hydrogen.

In some aspects, a method may comprise mixing an aqueous acidic ferrous iron solution with metallic iron, converting the residual ferric ions in the aqueous acidic ferrous iron solution to ferrous ions while producing hydrogen from the reaction of the residual acid with metallic iron, collecting the hydrogen, transferring the hydrogen to a reaction chamber, and thermally reducing iron feedstock in the reaction chamber with the hydrogen.

In some aspects, aspects disclosed herein include: a method for dissolving iron oxide materials in acidic solution, the method comprising: providing a feedstock comprising iron oxide materials; providing a dissolution tank; providing an electrochemical cell having a cathode, a membrane and an anode; dissolving the feedstock in the dissolution tank using in an acid solution, wherein the dissolution liberates Fe³⁺ into the acid solution; and circulating the acid solution between the dissolution tank and the cathode of the electrochemical cell to electrochemically reduce Fe³⁺ to Fe²⁺, and simultaneously generating protons, wherein the step of circulating comprises returning the reduced and acidified solution comprising the acid and Fe²⁺ ions to the dissolution tank to dissolve more iron oxide materials.

### Example: Ore Pre-Treatment and Dissolution

This example provides certain exemplary and optional aspects of a method of processing ore, to increase content of magnetite in an iron-containing ore. Processing feedstock ore to convert certain iron oxides to magnetite is an optional aspect that may be advantageous for some applications, but is not necessary for the operation of the methods disclosed herein for producing high-purity iron.

In an aspect, a method for processing an iron-containing ore having one or more non-magnetite iron oxide materials comprises: processing the iron-containing ore to form a processed ore, the step of processing comprising: exposing the one or more non-magnetite iron oxide materials of the iron-containing ore to a reductant at a temperature selected from the range of 200° C. to 600° C. to convert at least a portion of the one or more non-magnetite iron oxide materials to magnetite thereby forming the processed ore; and dissolving at least a portion of the magnetite using an acidic solution to form an iron-salt solution; wherein the reductant is at least partially a product of: an electrochemical process, a process for making iron, a chemical reaction involving iron as a reagent, and/or a chemical reaction between a metal and an acid.

Optionally in the method for processing an iron-containing ore, at least a portion of the reductant is a product of an electrochemical and/or chemical reaction of the process of making iron. Optionally in the method for processing an iron-containing ore, at least a portion of the reductant is a product of an iron electroplating process. Optionally in the method for processing an iron-containing ore, at least a portion of the reductant is electrochemically-generated H₂. Optionally in the method for processing an iron-containing ore, at least a portion of the reductant is chemically-generated H₂. Optionally in the method for processing an iron-containing ore, at least a portion of the reductant is H₂ generated via water electrolysis. Optionally in the method for processing an iron-containing ore, at least a portion of the reductant is H₂ generated from a reaction between a metal, such as iron, and an acid. Optionally in the method for processing an iron-containing ore, at least a portion of the reductant is H₂ a combination of an electrochemically-generated H₂ and a product of a chemical reaction between a metal and an acid.

The reductant may be sourced from a process that is a part of the method for processing an iron-containing ore and/or from a separate method. Optionally in the method for processing an iron-containing ore, the method comprises the process for making iron. Optionally in the method for processing an iron-containing ore, the method comprises electroplating iron metal, collecting the reductant produced during the step of electroplating, and providing the reductant to the step of processing. Optionally in the method for processing an iron-containing ore, the method comprises the electrochemical process, the process for making iron, the chemical reaction involving iron as a reagent, and/or the chemical reaction between a metal and an acid. Optionally in the method for processing an iron-containing ore, the method comprises the process for making electrochemically-generated H₂. Optionally in the method for processing an iron-containing ore, the method comprises the process for making H₂ via a reaction between a metal, such as iron, and an acid.

Optionally in the method for processing an iron-containing ore, the reductant comprises H₂, CO, natural gas, syngas, or any combination thereof.

Optionally in the method for processing an iron-containing ore, the method comprises extracting the at least a portion of the magnetite from the processed ore between the steps of processing and dissolving.

In some aspects, the conversion of the non-magnetite iron oxides to magnetite may be incomplete after first performing the step of exposing, resulting in some amount of unconverted non-magnetite iron oxide, which may then be processed further. Optionally in the method for processing an iron-containing ore, the processed ore comprises unconverted non-magnetite iron oxide material; and wherein the method further comprises: separating at least a portion of the unconverted non-magnetite iron oxide materials from the magnetite of the processed ore; and recycling the separated unconverted non-magnetite iron oxide material back to the step of processing to convert the unconverted non-magnetite iron oxide material to magnetite. Optionally in the method for processing an iron-containing ore, the step of dissolving comprises exposing the processed ore to the acidic solution; wherein at least a portion of the exposed processed ore is undissolved in the acidic solution; wherein the undissolved portion of the processed ore comprises unconverted non-magnetite iron oxide material; and wherein the method further comprises: recycling the unconverted non-magnetite iron oxide material back to the step of processing to convert the unconverted non-magnetite iron oxide material to magnetite.

Optionally in the method for processing an iron-containing ore, the one or more non-magnetite iron oxide materials comprise hematite and/or goethite.

Optionally in the method for processing an iron-containing ore, the acidic solution (for dissolving the at least a portion of the magnetite) comprises hydrochloric acid, sulfuric acid, nitric acid, phosphoric acid, acetic acid, citric acid, oxalic acid, boric acid, or any combination thereof.

Optionally in the method for processing an iron-containing ore, the iron-salt solution comprises aqueous Fe²⁺ and/or Fe³⁺ ions.

In another aspect, a method for processing an iron-containing ore having one or more non-magnetite iron oxide materials comprises: processing the iron-containing ore to form a processed ore, the step of processing comprising: exposing the one or more non-magnetite iron oxide materials of the iron-containing ore to a reductant at a temperature selected from the range of 200° C. to 600° C. to convert at least a portion of the one or more non-magnetite iron oxide materials to magnetite thereby forming the processed ore; and dissolving at least a portion of the magnetite using an acidic solution to form an iron-salt solution.

### Iron Plating Subsystem

In some aspects, a lead oxide electrode may be used as a relatively low cost oxygen evolution anode in a plating cell, which may make lower current-density operation more economically practical. In an alternative aspect, the plating cell anode may be a hydrogen oxidation anode configured to oxidize hydrogen gas provided from a source such as a hydrogen storage device or directly from a water electrolyzer (e.g., a PEM, AEM or alkaline water electrolyzer). Another approach to decreasing cost of the plating cell is to couple the iron deposition (ferrous reduction) reaction with a different oxidation reaction, such as oxidizing a portion of the ferrous solution from the dissolution subsystem.

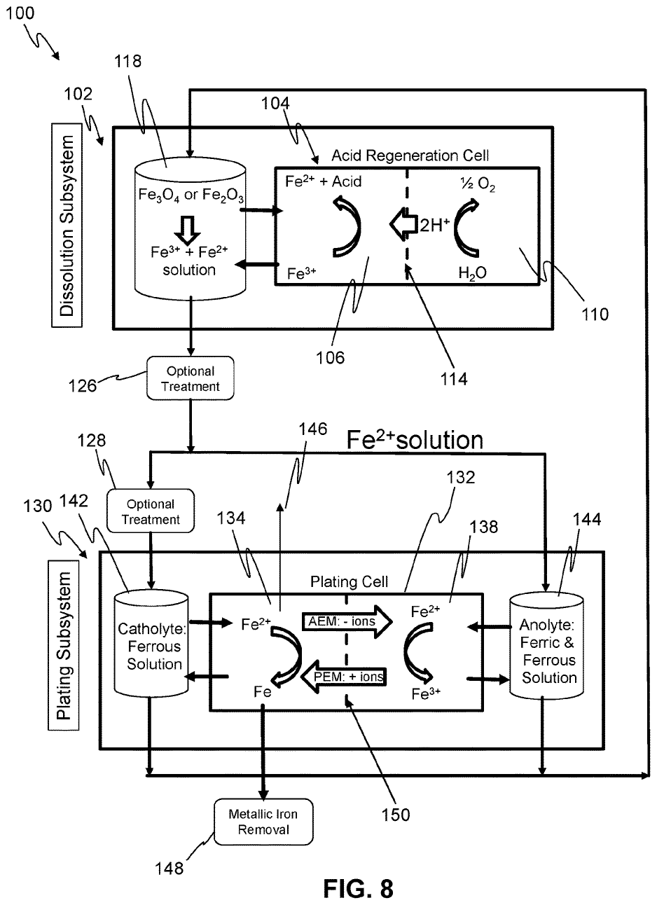

With reference to FIGS. 1 and 8, for example, some aspects of an iron conversion system 100 may include a plating subsystem 130 configured to produce iron metal from the aqueous iron solution produced in the dissolution subsystem. As described above, the process of dissolution in the dissolution subsystem 102 may be operated until the iron concentration in the solution reaches a desired value. At that point (or after subsequent treatment such as an “accessory iron” treatment), the solution is preferably a predominantly ferrous solution. In some aspects, the solution may then be divided into two separate streams representing a catholyte and an anolyte to be used in a plating cell 132.

The solution exiting the dissolution subsystem 102 may be transferred to a plating subsystem 130 via a transfer system 164. The transfer system 164 is illustrated as a simple conduit but may include any number of flow control or process control devices as needed. Similarly, at the end of a plating process some spent electrolyte solution(s) may be transferred from the plating subsystem 130 to the dissolution subsystem 102 at transfer 166, which may also include any number of flow control or process control devices as needed.

In some aspects, a solution entering a plating subsystem 130 may be divided into catholyte and anolyte streams in approximately one-third and two-thirds proportions of the original liquid volume entering the plating subsystem 130. The one-third volume may be directed to and stored in one or more catholyte storage tanks 142, and the two-thirds volume may be directed to and be stored in one or more separate anolyte storage tanks 144. For simplicity of description, it is assumed herein that there is one catholyte storage tank and one anolyte storage tank. In various aspects, the two tanks 142, 144 may have different volumes, or may have the same volume and the volumes may be used at different volumetric rates. The catholyte 142 and anolyte 144 tanks may be fluidically connected to the cathode chamber 134 and anode chamber 138, respectively, of an electrochemical plating cell 132.

The plating cell 132 may include a cathode chamber 134 having a cathode electrode 136, a membrane 150 and an anode chamber 138 having an anode electrode 140. The two electrodes 136, 140 are separated by a membrane 150, which may be a PEM, AEM, or microporous separator. Additional components typical of an electrochemical cell or stack may include current collectors, bipolar plates, flow channels, end plates, etc., depending on a chosen plating cell configuration. Example plating cell configurations are described elsewhere herein, but any plating cell configuration may be used.

In some aspects, any numbered items labeled in FIGS. 1 and 8 and not explicitly identified herein are described in PCT'712 and in U.S. Pat. No. 11,767,604, issued Sep. 26, 2023, which is incorporated herein by reference in its entirety.

As shown in FIG. 8, a plating 132 cell may be configured to plate metallic iron at a cathode electrode 136 while oxidizing a portion of the Fe²⁺ ions to Fe³⁺ ions. In this configuration, the cost of an oxygen evolution anode is avoided by using a very low-cost carbon or graphite anode material.

When an electrical current is applied across the plating cell, iron metal is electroplated on the cathode by reducing ferrous ions according to:

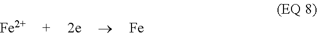

Simultaneously, the anolyte stream of ferrous solution may be oxidized to ferric on the anode of the plating cell, according to:

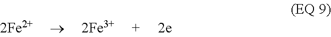

Combining (EQ 8) and (EQ 9) gives the overall plating cell reaction:

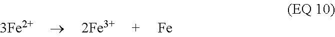

The iron electroplating reaction requires two electrons per ferrous (Fe²⁺) ion while the oxidation of ferrous to ferric (Fe³⁺) only requires one electron per ion. To achieve charge balance, there is a need for twice as much ferrous ions on the anode side 138 of the plating cell 132 than on the cathode side 134. This is the reason for splitting the ferrous solution entering the plating subsystem into ⅓ (catholyte) and ⅔ (anolyte) portions of the initial ferrous solution from the acid regeneration cell 104. This implies that the flow rate of the anolyte through the anode side 138 of the plating cell 132 may be double of that of the catholyte through the cathode side 134. In some aspects, the anolyte flow rate may be more than twice the catholyte flow rate. In some aspects, the anolyte flow rate may be less than twice the catholyte flow rate.

In some aspects, ferrous solution entering the plating subsystem 130 may be divided into anolyte and catholyte portions in different proportions, depending on efficiency of one or both electrodes, total iron concentration, or other factors. Therefore, in various aspects, the ferrous solution entering the plating subsystem may be divided into catholyte and anolyte portions in catholyte/anolyte ratios from about 90%/10% to about 20%/80%, optionally 70%/30% to about 30%/70%, and in some particular aspects catholyte/anolyte ratios may include 80%/20%, 70%/30%, 75%/25%, 70%/30%, 65%/45%, 60%/40%, 65%/35%, 50%/50%, 45%/65%, 40%/60%, 35%/65%, 33%/67%, 30%/70%, 25%/75%, 20%/80% (all values may vary by +/−3%).

The plating anolyte and catholyte may be recirculated between their respective tanks 144, 142 and their respective half-cell chambers 138, 134 in the plating cell 132 for any number of plating cycles (where one plating cycle comprises fully replacing a volume of anolyte and catholyte in the plating cell). In some aspects, the fluid circulation of plating anolyte and plating catholyte may be continuous when electrical current is applied.

In some aspects, plated iron may be removed at 148 from the cathode chamber 134 and/or cathode substrate, and plating electrolytes may be recycled to the dissolution subsystem 102 for re-use in further dissolution and acid regeneration operations. In some aspects, a plating process may be complete once a desired quantity of iron has been plated in a batch mode. In other aspects, plated iron may be continuously removed from the plating cathode chamber 134, and electrolytes may be replaced once reactants (e.g., Fe²⁺) are consumed beyond a desired point.

In various aspects, the plating cathode half-cell 134 may be configured to plate iron in any manner allowing for removal of the plated iron material. Various plating and metal removal methods are used in other hydrometallurgical plating operations, any of which may be adapted for use in this iron plating system.

Depending on a chosen method of plating and removing iron from the cathode half-cell, the plating cell may be operated in a batch mode, in which plating is stopped once a desired quantity of iron has been plated so that the iron may be removed. Alternatively, the plating cell may be configured such that plating operates in a continuous mode with iron being removed from the cathode chamber continuously. In some aspects, continuous plated iron removal may be similar to configurations used in some conventional zinc and copper electrowinning systems.

For example, iron may be plated as a plate or sheet onto a solid metal or graphite substrate (e.g., steel, copper, lead, zinc, nickel, or other material coated or plated with one or more of these or other metals or their alloys). In various aspects, the plating cathode electrode and/or substrate 136 may be removable from the cathode chamber 134, or may be configured such that iron may be removed from the cathode chamber 134 without removing the cathode electrode 136 or substrate. In some aspects, a substrate may be removable from a cathode electrode. In some aspects, such a substrate may be substantially flat, and plated iron may be removed in a batch mode by chipping, prying, scraping, bending or otherwise separating a flat iron plate from the substrate. In other aspects, a substrate may be cylindrical, and plated iron may be continuously removed by rotating the cylinder against one or more knives separating the plated iron as a continuous sheet, wire, strip, or other material. In still other aspects, iron may be plated onto a continuous belt travelling through a plating cell cathode, and iron may be detached from the belt at a location outside of the cathode chamber. In other aspects, iron may be plated onto seed particles which may increase in size in a particle growth manner, and the particles may be removed from the cathode chamber by any suitable separation mechanism. Various other iron plating and removal processes may also be used.

In various aspects, the end of plating may be determined based on a mass of iron plated, a measured remaining concentration of ferrous ions in the plating catholyte, a cell voltage, or other metrics. For example, in some aspects, a plating cycle may be complete when a target thickness of between about 1 mm and about 10 mm is reached.

Once the plating anolyte and catholyte are substantially depleted of reactants. i.e. of ferrous, the electrolytes may be directed to another process. In some aspects, the catholyte may have a lower ferrous content than initially, and the anolyte may have predominantly ferric instead of ferrous species. In some aspects, the spent anolyte and catholyte may be combined and directed back to the dissolution tank or the acid regeneration cell 104 of the dissolution subsystem to be re-used in a new dissolution cycle.

In some aspects, it may be desirable to maintain at least a minimum concentration of Fe²⁺ ions in the plating catholyte during plating. Experiments have shown that when the plating catholyte ferrous concentration falls below about 0.25 M, plating cell efficiency and plating quality tend to degrade. Therefore, in some aspects, it may be desirable to maintain a ferrous concentration of at least 0.25 M or more throughout the plating process.

In order to effectively maintain a minimum ferrous concentration and optimally use electrolyte, an alternative approach to establishing anolyte and catholyte volumes for the plating subsystem may be used. For example, in order to maintain a minimum ferrous concentration in the plating catholyte, it may be beneficial to stop plating when catholyte ferrous concentration falls to a low point (e.g., as measured by optical, spectroscopic, or other methods) or when plating cell voltage rises above a set point (e.g., above about 2.4 V, 2.5 V, 2.6 V, 2.7 V, 2.8 V, 2.9 V, or 3 V, in various aspects), and then using the “spent” catholyte as anolyte in a new plating process.

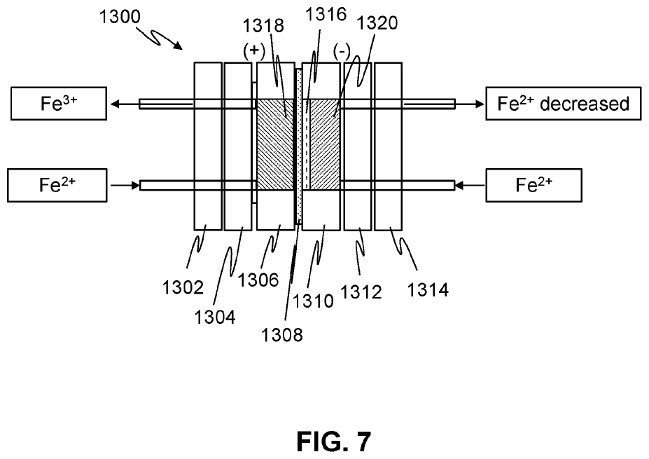

FIG. 7 illustrates an experimental plating cell 1300 comprising compression end plates 1302 and 1314, current collecting plates 1304, 1312, electrode-carrying plates 1306 and 1310 supporting an anode 1318 and a cathode electrode 1320 with a gap 1316 into which plated iron may expand. A separator 1308 divides the anode-containing chamber from the cathode-containing chamber.

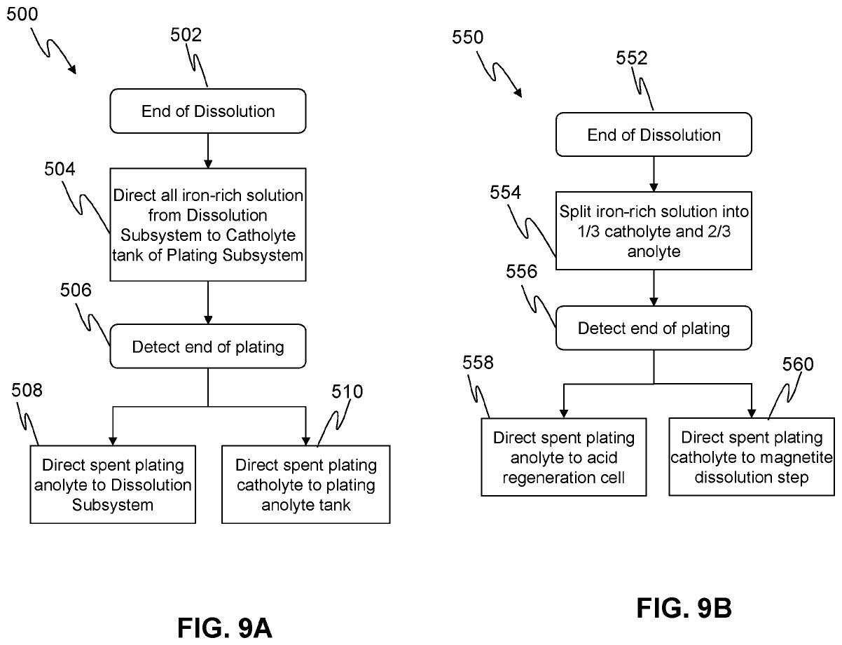

FIG. 9A and FIG. 9B illustrate aspects for storing and using plating anolyte and plating catholyte solutions which may advantageously facilitate maintaining at least a minimum ferrous concentration in the plating catholyte while producing a ferric-rich solution to be returned to the dissolution subsystem at the completion of plating. FIG. 9A illustrates a process 500 in which, after the end of a dissolution process 502 (and optionally after performing an “accessory iron” step), 100% of the iron-rich solution may be directed to the plating catholyte tank while the plating anolyte tank comprises “spent” catholyte from a previous plating cycle at block 510. A plating process may then be performed, plating iron from the catholyte and oxidizing ferrous to ferric in the anolyte. At the end of the plating process 506, the spent anolyte may be returned at 508 to the dissolution subsystem and the spent catholyte may be directed at 510 to the plating anolyte tank for the next plating cycle. In various aspects, “directing the spent catholyte to the anolyte tank” may comprise actually moving the spent catholyte to a separate tank, or merely changing controls (e.g., valves, pumps, etc.) to designate the tank containing spent catholyte as a new anolyte tank.

FIG. 9B illustrates an alternative process 550 in which, after the end of a dissolution cycle 552 (and optionally after performing an “accessory iron” step), the iron-rich solution from the dissolution subsystem may be divided at 554 into approximate ⅓ catholyte and ⅔ anolyte quantities, and plating may proceed as described above. At the end of plating 556, the spent plating anolyte (which contains predominantly ferric) may be directed at 558 back to the acid regenerator of the dissolution subsystem, and the spent plating catholyte may be directed to a hematite dissolution step near the end of the dissolution process in the dissolution subsystem at block 560. In an aspect, for example, anolyte and catholyte are combined together and at least a portion of the combined solution is sent to the dissolution subsystem/acid regeneration cell.

In some aspects, the electrolytes and solutions in either the dissolution subsystem and the plating subsystem may contain dissolved iron species, acid and additionally inert salts serving as supporting electrolyte to enhance the electrolyte conductivity, which may be particularly beneficial at low ferrous concentrations. Supporting salts may include any electrochemically inert salt such as sodium chloride, potassium chloride, ammonium chloride, sodium sulfate, potassium sulfate, ammonium sulfate, or others, or combinations of salts. The concentration of the supporting salts in the solution, if used, may range from about 0.1 to about 1 M.

In various aspects, a ferrous-oxidizing anode of the plating cell may be any carbon or graphite based electrode such as carbon/graphite felt, paper or cloth or any electrode material stable in the ferric/ferrous salt environment. The cathode of the plating cell, which is the plating electrode may be any conductive substrate suitable for electroplating including but not limited to sheet, plate, mesh, etc. and may be made of any material including carbon, graphite, steel, stainless steel, copper, zinc, titanium, or alloys or other combinations of these or other materials. Additionally, the substrate may comprise a multilayer structure with a core made of one type of material (e.g., a metal) for structural purpose and the surface made of another type of material for compatibility with the plating process and/or the acid solution. Examples of such multilayer structures include, copper-cladded or aluminum-cladded steel or stainless steel, copper plated steel or stainless steel or other multilayer materials.

FIG. 19 of PCT'712 illustrates an experimentally determined relationship between current density (measured in mA/cm²) and cell voltage for an acid regeneration cell 104. FIG. 20 of PCT'712 illustrates an experimentally determined relationship between current density (measured in mA/cm²) and cell voltage for an iron plating cell. As can be seen, the acid regeneration cell can be operated at much higher current densities before reaching the cell voltage achieved by the plating cell at a much lower current density. The water-splitting reaction in the acid regeneration cell may also typically use more expensive catalysts, leading to increased capital expenses for such a cell. These factors suggest that it may be more cost-efficient to operate the acid regeneration cell at higher current densities to get value from the more-expensive cell. On the other hand, the iron plating reaction may be best performed at relatively low current densities to achieve plated iron with desired properties. Because the iron plating cell also typically uses less-expensive electrodes, operating the plating cell at a lower current density is more economically viable. In various aspects, the current density applied to a plating cell may be in a range of about 20 to 300 mA/cm².

In various aspects, the plating catholyte and plating anolyte tanks may be maintained at temperatures between 40 to 80° C., and the plating cell may be operated at a similar range of temperature.

As will be understood with reference to the drawings, the de-coupling of the feedstock dissolution and acid-regeneration step from the iron plating (deposition) step provides substantial advantages at little or no theoretical cost, since the two processes together fundamentally consume the same total theoretical energy as the one-step iron conversion process described above. Relatedly, decoupling of the dissolution tanks from the plating anolyte and plating catholyte tanks may provide further advantages to managing the different reaction rates of the two processes.

In various aspects, the iron plating cell(s) may be advantageously operated at a current density of between about 20 mA/cm² to about 500 mA/cm², optionally 20 mA/cm² to about 200 mA/cm² and optionally 20 mA/cm² to about 100 mA/cm², and in some aspects between about 50 mA/cm² and about 300 mA/cm² optionally 50 mA/cm² to about 200 mA/cm² and optionally 50 mA/cm² to about 100 mA/cm², and in some aspects between about 75 mA/cm² and about 250 mA/cm², optionally 75 mA/cm² to about 200 mA/cm² and optionally 75 mA/cm² to about 100 mA/cm². In an aspect, the iron plating cell(s) may be operated at a current density of less than or equal to 500 mA/cm², optionally, less than or equal to 400 mA/cm², optionally, less than or equal to 300 mA/cm², optionally, less than or equal to 200 mA/cm², optionally less than or equal to 100 mA/cm². In some aspects, plating current densities may be variable during plating operation depending on process conditions and/or availability of electricity.

### Various Additional Aspects

Various aspects are contemplated herein, several of which are set forth in the paragraphs below. It is explicitly contemplated that any aspect or portion thereof can be combined to form an aspect. In addition, it is explicitly contemplated that: any reference to aspect 1 includes reference to aspects 1a, 1b, 1c, and/or 1d, any reference to aspect 5 includes reference to aspects 5a and 5b, and so on (any reference to an aspect includes reference to that aspects lettered versions). Moreover, the terms “any preceding aspect” and “any one of the preceding aspects” means any aspect that appears prior to the aspect that contains such phrase (in other words, the sentence “Aspect 32: The method or system of any preceding aspect . . . ” means that any aspect prior to aspect 32 is referenced, including aspects 1a through 31). For example, it is contemplated that, optionally, any system or method of any the below aspects may be useful with or combined with any other aspect provided below. Further, for example, it is contemplated that any aspect described above may, optionally, be combined with any of the below listed aspects.

Aspect 1a: A method of dissolving and purifying an ore containing hematite and/or magnetite iron oxide, the method comprising:
thermally reducing a first portion of the ore at sufficient temperature and for a sufficient time to convert a portion of the iron oxide to magnetite to produce high-magnetite ore;
thermally reducing a second portion of the ore at sufficient temperature and for a sufficient time to convert a portion of the iron oxide to metallic iron to produce high-metallic ore;
first contacting an acid solution with the high-magnetite ore; and then
second contacting the acid solution with the high-metallic ore until at least one precipitate is formed.

Aspect 1b: In an iron conversion system comprising an acid regeneration cell, an impurity removal vessel, and an iron electroplating cell that is separate from the acid regeneration cell, a method comprising:
electroplating metallic iron from an electrolyte solution containing ferrous iron ions and less than 0.1 mol/l ferric iron ions and less than 0.01 mol/l aluminum ions;
determining that the ferrous iron ion concentration has dropped to a pre-determined low-end ferrous concentration;
concentrating the electrolyte by removing water until the ferrous iron ion concentration rises to a pre-determined high-end ferrous concentration; and
   electroplating metallic iron from the concentrated electrolyte.

Aspect 1c: In an iron conversion system comprising an acid regeneration cell, an impurity removal vessel, and an iron electroplating cell that is separate from the acid regeneration cell, a method comprising:
in a purifying plating cell, first electroplating metallic iron from an electrolyte solution containing ferrous iron ions and more than 0.01 mol/l aluminum ions; to form a purified electrolyte and a lower-purity iron product;
collecting a precipitate containing at least one aluminum compound from the purifying plating cell; and
   after said first electroplating, directing the purified electrolyte into a product plating cell and electroplating a higher-purity iron product.

Aspect 1d: In an iron conversion system comprising an acid regeneration cell and an iron electroplating cell that is separate from the acid regeneration cell, a method comprising:
crystallizing ferrous sulfate from a first electrolyte solution exiting the acid regeneration solution;
dissolving the ferrous sulfate crystals in a second electrolyte solution; and
   electroplating metallic iron from the second electrolyte solution in the electroplating cell.

Aspect 1e: The method of any of Aspects 1b-1d, wherein: the iron conversion system is according to any aspect(s) herein and/or according to any aspect(s) in PCT'712, the acid regeneration cell is according to any aspect(s) herein and/or according to any aspect(s) in PCT'712, the impurity removal vessel is according to any aspect(s) herein and/or according to any aspect(s) in PCT'712, and the iron electroplating cell is according to any aspect(s) herein and/or according to any aspect(s) in PCT'712.

Aspect 2a: The method of any preceding Aspect, wherein the second portion is about 1% of the first portion. Aspect 2b: The method of any preceding Aspect, wherein the second portion is selected from the range of being approximately 1% (optionally approximately 2%, optionally approximately 3%, optionally approximately 4%, optionally approximately 5%, optionally approximately 6%, optionally approximately 7%, optionally approximately 8%, optionally approximately 9%, optionally approximately 10%, optionally approximately 11%, optionally approximately 12%, optionally approximately 13%, optionally approximately 14%, optionally approximately 15%, optionally approximately 16%, optionally approximately 17%, optionally approximately 18%, optionally approximately 19%, optionally approximately 20%, optionally approximately 22%, optionally approximately 24%, optionally approximately 25%, optionally approximately 26%, optionally approximately 28%, optionally approximately 29%, optionally approximately 30%, optionally approximately 31%, optionally approximately 32%, optionally approximately 34%, optionally approximately 36%, optionally approximately 38%, optionally approximately 39%, optionally approximately 40%, optionally approximately 41%) of the first portion to approximately 50% (optionally approximately 49%, optionally approximately 48%, optionally approximately 47%, optionally approximately 46%, optionally approximately 45%, optionally approximately 44%, optionally approximately 42%, optionally approximately 41%, optionally approximately 40%, optionally approximately 39%, optionally approximately 38%, optionally approximately 36%, optionally approximately 35%, optionally approximately 34%, optionally approximately 32%, optionally approximately 31%, optionally approximately 30%, optionally approximately 29%, optionally approximately 28%, optionally approximately 26%, optionally approximately 25%, optionally approximately 24%, optionally approximately 22%, optionally approximately 21%, optionally approximately 20%, optionally approximately 19%, optionally approximately 18%, optionally approximately 16%, optionally approximately 15%, optionally approximately 14%, optionally approximately 12%, optionally approximately 11%, optionally approximately 10%) of the first portion, wherein any value and range therebetween is explicitly contemplated and disclosed herein, such as for example optionally selected from the range of being approximately 2% of the first portion to approximately 50% of the first portion, such as for example optionally selected from the range of being approximately 1% of the first portion to approximately 10% of the first portion, such as for example optionally being approximately 2% of the first portion, such as for example optionally being approximately 4% of the first portion, such as for example optionally being approximately 6% of the first portion, such as for example optionally being approximately 7% of the first portion, such as for example optionally being approximately 8% of the first portion, such as for example optionally being approximately 9% of the first portion, such as for example optionally being approximately 12% of the first portion, such as for example optionally being approximately 15% of the first portion.

Aspect 3: The method of any preceding Aspect, wherein the second portion is about 3% of the first portion.

Aspect 4: The method of any preceding Aspect, wherein the second portion is about 5% of the first portion.

Aspect 5: The method of any preceding Aspect, wherein the second portion is about 10% of the first portion.

Aspect 6: The method of any preceding Aspect, wherein the second portion is about 30% of the first portion.

Aspect 7: The method of any preceding Aspect, wherein the second portion is about 40% of the first portion.

Aspect 8: The method of any preceding Aspect, wherein the second portion is about 50% of the first portion.

Aspect 9: The method of any preceding Aspect, wherein the precipitate comprises at least one aluminum compound.

Aspect 10: The method of any preceding Aspect, wherein the precipitate comprises at least one phosphorous compound.

Aspect 11: The method of any preceding Aspect, wherein the precipitate comprises at least one titanium compound.

Aspect 12: The method of any preceding Aspect, wherein thermally reducing comprises use of a reducing gas comprising hydrogen gas.

Aspect 13: The method of any preceding Aspect, further comprising electroplating metallic iron from the acid solution after said second contacting.

Aspect 14: The method of Aspect 13, wherein said electroplating metallic iron comprises anodically evolving oxygen.

Aspect 15a: The method of any preceding Aspect, wherein said second contacting is performed when the acid solution is at a temperature of approximately 80° C.+/−10° C. Aspect 15b: The method of any preceding Aspect, wherein said second contacting is performed when the acid solution is at a temperature of approximately 50° C.+/−10° C. Aspect 15c: The method of any preceding Aspect, wherein said second contacting is performed when the acid solution is at a temperature of approximately 60° C.+/−10° C. Aspect 15d: The method of any preceding Aspect, wherein said second contacting is performed when the acid solution is at a temperature of approximately 70° C.+/−10° C. Aspect 15e: The method of any preceding Aspect, wherein said second contacting is performed when the acid solution is at a temperature of approximately 90° C.+/−10° C. Aspect 15f: The method of any preceding Aspect, wherein said second contacting is performed when the acid solution is at a temperature selected from the range of approximately 45° C. (optionally approximately 50° C., optionally approximately 55° C., optionally approximately 60° C., optionally approximately 65° C., optionally approximately 70° C., optionally approximately 75° C., optionally approximately 80° C.) to approximately 95° C. (optionally approximately 90° C., optionally approximately 85° C., optionally approximately 80° C.), wherein any value and range therebetween is explicitly contemplated and disclosed herein.

Aspect 16a: In an iron conversion system (according to any aspect(s) herein and/or according to any aspect(s) in PCT'712) comprising an acid regeneration cell (according to any aspect(s) herein and/or according to any aspect(s) in PCT'712), an impurity removal vessel (according to any aspect(s) herein and/or according to any aspect(s) in PCT'712), and an iron electroplating cell (according to any aspect(s) herein and/or according to any aspect(s) in PCT'712) that is separate from the acid regeneration cell, a method comprising:
electroplating metallic iron from an electrolyte solution containing ferrous iron ions and less than 0.1 mol/l ferric iron ions and less than 0.01 mol/l aluminum ions;
determining that the ferrous iron ion concentration has dropped to a pre-determined low-end ferrous concentration;
concentrating the electrolyte by removing water until the ferrous iron ion concentration rises to a pre-determined high-end ferrous concentration; and
electroplating metallic iron from the concentrated electrolyte.

Aspect 16b: A method comprising:
electroplating metallic iron from an electrolyte solution containing ferrous iron ions and less than 0.1 mol/l ferric iron ions and less than 0.01 mol/l aluminum ions;
determining that the ferrous iron ion concentration has dropped to a pre-determined low-end ferrous concentration;
concentrating the electrolyte by removing water until the ferrous iron ion concentration rises to a pre-determined high-end ferrous concentration; and electroplating metallic iron from the concentrated electrolyte;
   wherein the method is performed in an iron conversion system (according to any aspect(s) herein and/or according to any aspect(s) in PCT'712) comprising an acid regeneration cell (according to any aspect(s) herein and/or according to any aspect(s) in PCT'712), an impurity removal vessel (according to any aspect(s) herein and/or according to any aspect(s) in PCT'712), and an iron electroplating cell (according to any aspect(s) herein and/or according to any aspect(s) in PCT'712) that is separate from the acid regeneration cell.

Aspect 17a: The method of any preceding Aspect, wherein the low-end ferrous concentration is about 1 mol/l Fe²⁺ ions. Aspect 17a: The method of any preceding Aspect, wherein the low-end ferrous concentration is selected from the range of approximately 1.0 mol/l Fe²⁺ ions to approximately 1.3 mol/l Fe²⁺ ions, wherein any value and range therebetween is explicitly contemplated and disclosed herein.

Aspect 18: The method of any preceding Aspect, wherein the low-end ferrous concentration is about 1.1 mol/l Fe²⁺ ions.

Aspect 19: The method of any preceding Aspect, wherein the low-end ferrous concentration is about 1.2 mol/l Fe²⁺ ions.

Aspect 20: The method of any preceding Aspect, wherein the low-end ferrous concentration is about 1.3 mol/l Fe²⁺ ions.

Aspect 21a: The method of any preceding Aspect, wherein the high-end ferrous concentration is about 1.3 mol/l Fe²⁺ ions. Aspect 21b: The method of any preceding Aspect, wherein the high-end ferrous concentration is selected from the range of approximately 1.3 mol/l Fe²⁺ ions to approximately 2.0 mol/l Fe²⁺ ions, wherein any value and range therebetween is explicitly contemplated and disclosed herein.

Aspect 22: The method of any preceding Aspect, wherein the high-end ferrous concentration is about 1.4 mol/l Fe²⁺ ions.

Aspect 23: The method of any preceding Aspect, wherein the high-end ferrous concentration is about 1.5 mol/l Fe²⁺ ions.

Aspect 24a: The method of any preceding Aspect, wherein the high-end ferrous concentration is about 1.6 mol/l Fe²⁺ ions. Aspect 24b: The method of any preceding Aspect, wherein the high-end ferrous concentration is about 1.8 mol/l Fe²⁺ ions. Aspect 24c: The method of any preceding Aspect, wherein the high-end ferrous concentration is about 1.9 mol/l Fe²⁺ ions.

Aspect 25: The method of any preceding Aspect, wherein the high-end ferrous concentration is about 2 mol/l Fe²⁺ ions.

Aspect 26: The method of any preceding Aspect, wherein concentrating comprises use of a multiple effect evaporation process.

Aspect 27: The method of any preceding Aspect, wherein concentrating comprises use of a shell-and-tube heat exchanger.

Aspect 28: The method of any preceding Aspect, wherein concentrating comprises use of a mechanical vapor recompression process.

Aspect 29: The method of any preceding Aspect, wherein concentrating comprises use of a mechanical vapor recompression process followed by use of a multiple effect evaporation process.

Aspect 30a: In an iron conversion system (according to any aspect(s) herein and/or according to any aspect(s) in PCT'712) comprising an acid regeneration cell (according to any aspect(s) herein and/or according to any aspect(s) in PCT'712), an impurity removal vessel (according to any aspect(s) herein and/or according to any aspect(s) in PCT'712), and an iron electroplating cell (according to any aspect(s) herein and/or according to any aspect(s) in PCT'712) that is separate from the acid regeneration cell, a method comprising:
in a purifying plating cell, first electroplating metallic iron from an electrolyte solution containing ferrous iron ions and more than 0.01 mol/l aluminum ions; to form a purified electrolyte and a lower-purity iron product;
collecting a precipitate containing at least one aluminum compound from the purifying plating cell; and
after said first electroplating, directing the purified electrolyte into a product plating cell and electroplating a higher-purity iron product.

Aspect 30b: A method comprising:
in a purifying plating cell, first electroplating metallic iron from an electrolyte solution containing ferrous iron ions and more than 0.01 mol/l aluminum ions; to form a purified electrolyte and a lower-purity iron product;
collecting a precipitate containing at least one aluminum compound from the purifying plating cell; and
   after said first electroplating, directing the purified electrolyte into a product plating cell and electroplating a higher-purity iron product;
   wherein the method is performed in an iron conversion system (according to any aspect(s) herein and/or according to any aspect(s) in PCT'712) comprising an acid regeneration cell (according to any aspect(s) herein and/or according to any aspect(s) in PCT'712), an impurity removal vessel (according to any aspect(s) herein and/or according to any aspect(s) in PCT'712), and an iron electroplating cell (according to any aspect(s) herein and/or according to any aspect(s) in PCT'712) that is separate from the acid regeneration cell.

Aspect 31: The method of any preceding Aspect, further comprising operating the purifying plating cell at a current density of at least 1 mA/cm² to electroplate iron powder.

Aspect 32: The method of any preceding Aspect, further comprising collecting at least a portion of the iron powder along with the precipitate.

Aspect 33: The method of any preceding Aspect, further comprising magnetically separating the iron powder from the precipitate.

Aspect 34: The method of any preceding Aspect, further comprising, leaving a portion of the low-purity iron product in the purifying plating cell, removing the electrolyte solution from the purifying plating cell, and introducing a new electrolyte solution into the purifying plating cell.

Aspect 35a: In an iron conversion system (according to any aspect(s) herein and/or according to any aspect(s) in PCT'712) comprising an acid regeneration cell (according to any aspect(s) herein and/or according to any aspect(s) in PCT'712) and an iron electroplating cell (according to any aspect(s) herein and/or according to any aspect(s) in PCT'712) that is separate from the acid regeneration cell, a method comprising:
crystallizing ferrous sulfate from a first electrolyte solution exiting the acid regeneration solution;
dissolving the ferrous sulfate crystals in a second electrolyte solution; and
electroplating metallic iron from the second electrolyte solution in the electroplating cell.

Aspect 35b: A method comprising:
crystallizing ferrous sulfate from a first electrolyte solution exiting the acid regeneration solution;
dissolving the ferrous sulfate crystals in a second electrolyte solution; and
   electroplating metallic iron from the second electrolyte solution in the electroplating cell;
   wherein the method is performed in an iron conversion system (according to any aspect(s) herein and/or according to any aspect(s) in PCT'712) comprising an acid regeneration cell (according to any aspect(s) herein and/or according to any aspect(s) in PCT'712) and an iron electroplating cell (according to any aspect(s) herein and/or according to any aspect(s) in PCT'712) that is separate from the acid regeneration cell.

Aspect 36: The method of any preceding Aspect, wherein crystallizing comprises decreasing a temperature of the first electrolyte solution or extracting water from the first electrolyte solution.

Aspect 37: The method of any preceding Aspect, wherein the second electrolyte solution is a purified ferrous sulfate solution exiting an impurity precipitation and filtration process.

Aspect 38: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to any preceding Aspect(s) or any combination of preceding Aspects and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) of any preceding Aspect or any combination of preceding Aspects.

Aspect 39: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) of any embodiment(s) and aspect(s) described herein, optionally in combination with any in PCT'712.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of any particular claimed invention. Thus, it should be understood that although inventions have been specifically disclosed by preferred embodiments, exemplary embodiments and optional features, modification and variation of the concepts herein disclosed may be resorted to by those skilled in the art, and that such modifications and variations are considered to be within the scope of inventions as defined by the appended claims. The specific embodiments provided herein are examples of useful embodiments of the inventions and it will be apparent to one skilled in the art that the inventions may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including iron oxide materials of an ore or structural and compositional polymorphs of the group members, are disclosed separately. When a Markush group or other grouping is used herein, all individual members of the group and all combinations and sub-combinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, system, subsystem, method, process, component, and/or combination of components, described or exemplified herein can be used to practice any claimed invention(s), unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the disclosed devices, systems, methods, and processes pertain. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's inventions, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The claimed inventions illustratively described herein suitably may be practiced in the absence of any element or elements, limitation or limitations which is not specifically disclosed herein.

One of ordinary skill in the art will appreciate that starting materials, reagents, synthetic methods, purification methods, analytical methods, and assay methods other than those specifically exemplified can be employed in the practice of the claimed inventions without resort to undue experimentation. All art-known functional equivalents, of any such materials and methods are intended to be included in these inventions.

The term “and/or” is used herein, in the description and in the claims, to refer to a single element alone or any combination of elements from the list in which the term and/or appears. In other words, a listing of two or more elements having the term “and/or” is intended to cover embodiments having any of the individual elements alone or having any combination of the listed elements. For example, the phrase “element A and/or element B” is intended to cover embodiments having element A alone, having element B alone, or having both elements A and B taken together. For example, the phrase “element A, element B, and/or element C” is intended to cover embodiments having element A alone, having element B alone, having element C alone, having elements A and B taken together, having elements A and C taken together, having elements B and C taken together, or having elements A, B, and C taken together.

We claim:

1. A method of dissolving and purifying an ore containing hematite and/or magnetite iron oxide, the method comprising:
thermally reducing a first portion of the ore at sufficient temperature and for a sufficient time to convert a portion of the iron oxide to magnetite to produce high-magnetite ore;
thermally reducing a second portion of the ore at sufficient temperature and for a sufficient time to convert a portion of the iron oxide to metallic iron to produce high-metallic ore;
first contacting an acid solution with the high-magnetite ore; and then
second contacting the acid solution with the high-metallic ore until at least one precipitate is formed.

2. The method of claim 1, wherein the second portion is about 1% of the first portion.

3. The method of claim 1 or 2, wherein the second portion is about 3% of the first portion.

4. The method of any of the preceding claims, wherein the second portion is about 5% of the first portion.

5. The method of any of the preceding claims, wherein the second portion is about 10% of the first portion.

6. The method of any of the preceding claims, wherein the second portion is about 30% of the first portion.

7. The method of any of the preceding claims, wherein the second portion is about 40% of the first portion.

8. The method of any of the preceding claims, wherein the second portion is about 50% of the first portion.

9. The method of any of the preceding claims, wherein the precipitate comprises at least one aluminum compound.

10. The method of any of the preceding claims, wherein the precipitate comprises at least one phosphorous compound.

11. The method of any of the preceding claims, wherein the precipitate comprises at least one titanium compound.

12. The method of any of the preceding claims, wherein thermally reducing comprises use of a reducing gas comprising hydrogen gas.

13. The method of any of the preceding claims, further comprising electroplating metallic iron from the acid solution after said second contacting.

14. The method of claim 13, wherein said electroplating metallic iron comprises anodically evolving oxygen.

15. The method of any of the preceding claims, wherein said second contacting is performed when the acid solution is at a temperature of 80° C.+/−10° C.

16. In an iron conversion system comprising an acid regeneration cell, an impurity removal vessel, and an iron electroplating cell that is separate from the acid regeneration cell, a method comprising:
electroplating metallic iron from an electrolyte solution containing ferrous iron ions and less than 0.1 mol/l ferric iron ions and less than 0.01 mol/l aluminum ions;
determining that the ferrous iron ion concentration has dropped to a pre-determined low-end ferrous concentration;
concentrating the electrolyte by removing water until the ferrous iron ion concentration rises to a pre-determined high-end ferrous concentration; and
electroplating metallic iron from the concentrated electrolyte.

17. The method of claim 16, wherein the low-end ferrous concentration is about 1 mol/l Fe²⁺ ions.

18. The method of claim 16 or 17, wherein the low-end ferrous concentration is about 1.1 mol/l Fe²⁺ ions.

19. The method of any of claims 16-18, wherein the low-end ferrous concentration is about 1.2 mol/l Fe²⁺ ions.

20. The method of any of claims 16-19, wherein the low-end ferrous concentration is about 1.3 mol/l Fe²⁺ ions.

21. The method of any of claims 16-20, wherein the high-end ferrous concentration is about 1.3 mol/l Fe²⁺ ions.

22. The method of any of claims 16-21, wherein the high-end ferrous concentration is about 1.4 mol/l Fe²⁺ ions.

23. The method of any of claims 16-22, wherein the high-end ferrous concentration is about 1.5 mol/l Fe²⁺ ions.

24. The method of any of claims 16-23, wherein the high-end ferrous concentration is about 1.6 mol/l Fe²⁺ ions.

25. The method of any of claims 16-24, wherein the high-end ferrous concentration is about 2 mol/l Fe²⁺ ions.

26. The method of any of claims 16-25, wherein concentrating comprises use of a multiple effect evaporation process.

27. The method of any of claims 16-26, wherein concentrating comprises use of a shell-and-tube heat exchanger.

28. The method of any of claims 16-27, wherein concentrating comprises use of a mechanical vapor recompression process.

29. The method of any of claims 16-28, wherein concentrating comprises use of a mechanical vapor recompression process followed by use of a multiple effect evaporation process.

30. In an iron conversion system comprising an acid regeneration cell, an impurity removal vessel, and an iron electroplating cell that is separate from the acid regeneration cell, a method comprising:
in a purifying plating cell, first electroplating metallic iron from an electrolyte solution containing ferrous iron ions and more than 0.01 mol/l aluminum ions; to form a purified electrolyte and a lower-purity iron product;
collecting a precipitate containing at least one aluminum compound from the purifying plating cell; and
after said first electroplating, directing the purified electrolyte into a product plating cell and electroplating a higher-purity iron product.

31. The method of claim 30, further comprising operating the purifying plating cell at a current density of at least 1 mA/cm² to electroplate iron powder.

32. The method of claim 31, further comprising collecting at least a portion of the iron powder along with the precipitate.

33. The method of claim 32, further comprising magnetically separating the iron powder from the precipitate.

34. The method of any of claims 30 to 33, further comprising, leaving a portion of the low-purity iron product in the purifying plating cell, removing the electrolyte solution from the purifying plating cell, and introducing a new electrolyte solution into the purifying plating cell.

35. In an iron conversion system comprising an acid regeneration cell and an iron electroplating cell that is separate from the acid regeneration cell, a method comprising:
crystallizing ferrous sulfate from a first electrolyte solution exiting the acid regeneration solution;
dissolving the ferrous sulfate crystals in a second electrolyte solution; and
electroplating metallic iron from the second electrolyte solution in the electroplating cell.

36. The method of claim 35, wherein crystallizing comprises decreasing a temperature of the first electrolyte solution or extracting water from the first electrolyte solution.

37. The method of claim 35 or 36, wherein the second electrolyte solution is a purified ferrous sulfate solution exiting an impurity precipitation and filtration process.
